(19) United States
(12) Patent Application Publication
(10) Pub. No.: US 2020/0382451 A1
(43) Pub. Date: Dec. 3, 2020

(54) CONVERSATIONAL LIMBIC COMPUTING SYSTEM AND RELATED METHODS

(71) Applicant: FACET LABS, LLC, Los Gatos, CA (US)

(72) Inventors: Stuart OGAWA, Los Gatos, CA (US); Lindsay SPARKS, Seattle, WA (US); Koichi NISHIMURA, San Jose, CA (US); Wilfred P. SO, Mississauga (CA); Jane W. CHEN, Los Gatos, CA (US); Camden Chen OGAWA, Los Gatos, CA (US); Joshua Yoshi OGAWA, Los Gatos, CA (US)

(21) Appl. No.: 16/638,641

(22) PCT Filed: Aug. 8, 2019
(86) PCT No.: PCT/US2019/045652

§ 371 Date: Feb. 12, 2020

Related U.S. Application Data
(60) Provisional application No. 62/715,976, filed on Aug. 8, 2018.

(51) Int. Cl. H04L 12/58; G10L 25/63; G06F 16/901; G09B 19/00; G06F 3/01; G10L 13/02

(52) U.S. Cl. CPC H04L 51/02; G10L 25/63; G10L 13/02; G09B 19/00; G06F 3/015; G06F 16/9024

(57) ABSTRACT

A conversational limbic computing system is provided that converses with a patient and provides familiar media content based on the patient's emotions and psychological state. The media content includes audio data of familiar people talking with the patient. It utilizes content learned from the patient and content provided by family, friends, caregivers, and doctors, and autonomously adjusts conversations based on the changing state of the patient's psychological or emotional state.

### CROSS-REFERENCE TO RELATED APPLICATIONS

The following claims priority to U.S. Provisional Patent Application No. 62/715,976 filed on Aug. 8, 2018 and titled “Conversational Limbic Computing System and Related Methods”, the entire contents of which are herein incorporated by reference.

### TECHNICAL FIELD

The following generally relates to interactive assistive devices and related computing architectures and methods for processing data and outputting user feedback, such as via audio or visual media, or both, to respond to the progression of emotions of people.

### DESCRIPTION OF THE RELATED ART

People sometimes are emotions related to fear, uncertainty, doubt and agitation. These emotions can damage the emotional well-being and the physical well-being of the person, and can affect the people that support that person. These negative emotions can be caused by different reasons, including and not limited to dementia.

Dementia afflicts 50 million people in the world and 10 million new cases arise each year. The dementia rate is doubling every 20 years reaching 75 million in 2030 and 131.5 million in 2050.

The National Institute on Aging conducted a study in 2010 estimating the annual cost to help dementia patients was $215 billion a year to care for dementia patients, surpassing heart disease ($102 billion) and cancer ($77 billion).

In some cases, it costs $7,000 to $12,000/month for around the clock dementia care. This cost precludes many families from being able to afford dedicated dementia care, and as a result families and relatives are typically relied upon to help loved ones. The toll and impact on family members taking care of dementia patients can break families apart and, at a minimum, causes severe anger and frustration among family members and friends.

In many cities, there are long waiting lists (e.g. many months long) to receive care from a memory care facility. The cost and availability of dedicated memory care units will continue to worsen as the aging baby boomer demographic rises. Globally, these same problems are occurring as noted in the first link above.

It is recognized that a patient's dementia state can vary over the course of a week, or even within day. This unpredictable patient behavior devastates caregivers through fatigue, energy loss, and anger. For example, a more passive, relaxed and engaging patient state could occur in the morning and regress to an agitated or fearful state in the afternoon. On a different day, the same patient could function normally, from a memory perspective throughout the morning and early afternoon, and then begin forgetting in the late afternoon, also known as “sundowner” syndrome. In either case, it is exhausting and challenging for a family members and care givers to long term communicate and support the loved one as the dementia changes throughout the day, day to day, week-to-week, etc.

It will be appreciated that “dementia” is an overall term for a set of symptoms that are caused by disorders affecting the brain. Symptoms may include memory loss and difficulties with thinking, problem-solving or language, severe enough to reduce a person's ability to perform everyday activities. A person with dementia may also experience changes in mood or behavior.

Dementia is progressive, which means the symptoms will gradually get worse as more brain cells become damaged and eventually die.

Dementia is not a specific disease. Many diseases can cause dementia, including Alzheimer's disease, vascular dementia (due to strokes), Lewy Body disease, head trauma, fronto-temporal dementia, Creutzfeldt-Jakob disease, Parkinson's disease, and Huntington's disease. These conditions can have similar and overlapping symptoms.

Mobile devices (e.g. cell phones, smart phones), wearable devices (e.g. smart watches), and on-body devices (e.g. trackers worn around the neck or embedded in clothing) have been used to help track persons with dementia and to provide audio reminders or text reminders. However, it is herein recognized that existing technologies are often too complex to use, especially when a person from dementia is suffering from cognitive lapse. These technologies also are perceived to be a threatening presence of constant surveillance, as these technologies are considered foreign to persons with dementia.

It is also herein recognized that existing technologies that attempt to be responsive to a person with dementia are too simplistic. A single response, or a limited set of responses, are used to react to a detected event of a person with dementia. Examples of responses include beeps, buzzes, flashing lights, text reminders, and pre-recorded voice messages. It is herein recognized that these approaches can be ineffective to help a person with dementia. Furthermore, these approaches are intended to “blanket” all persons with dementia, but is inappropriate since there are many different symptoms and levels of dementia, which vary over time (even within a day). In effect, these technologies can reduce or degrade the dignity of persons with dementia.

It is further herein recognized that dementia assistive devices that have more complex response functionalities, are typically slower and have delayed outputs to the person with dementia.

These, and other technical challenges, lead to limited adoption of assistive devices for dementia and other cognitive and mental health impairments.

### BRIEF DESCRIPTION OF THE DRAWINGS

Embodiments will now be described by way of example only with reference to the appended drawings wherein:

FIG. 1 is a schematic diagram of an example of a conversational limbic computing system for ingesting user data via user devices, and using machine learning to respond to the emotional state of a user.

FIG. 2 is another schematic diagram, show a Conversational Limbic System (CLS) bot that controls the activation of an Expand bot, a Reach bot, and an Address bot based on a psychological model according to an example embodiment.

FIG. 3 is a flow diagram of executable instructions for the Address bot to serve media content to a user device to redirect a user away from Topic 1 according to an example embodiment.

FIG. 4 is a flow diagram of executable instructions for the Reach bot to serve media content to a user device to engage a user with Topic 2, which includes content that is familiar to the user according to an example embodiment.

FIG. 5 is a flow diagram of executable instructions for the Expand bot to serve media content to a user device to engage a user with Topic 3, which includes content that is unfamiliar to the user according to an example embodiment.

FIG. 6 is a flow diagram of executable instructions for the CLS bot to control which one of the Address bot, Reach bot and the Expand bot to activate to serve media content to the user according to an example embodiment.

FIG. 7 is a flow diagram of executable instructions for the CLS bot to control which one of the Address bot, Reach bot and the Expand bot to activate to serve media content to the user according to another example embodiment.

FIG. 8 is a flow diagram of executable instructions for the CLS bot to predict the emotional or behavioral state of the user, and the CLS bot responsively activating one of the Address bot, Reach bot and the Expand bot according to an example embodiment.

FIG. 9 is a flow diagram of executable instructions for the conversational limbic computing system to engage a first user to generate teaching content for a second user.

FIG. 10 is a flow diagram of executable instructions for the conversational limbic computing system to generate and transmit a message about a given user based on a change of one dominant bot to a different bot.

FIG. 11 is a flow diagram of executable instructions for the conversational limbic computing system to generate and transmit a message about a given user based on how long a given bot is dominant for the given user.

FIG. 12 is a flow diagram of executable instructions for the conversational limbic computing system to generate and transmit a message about a given user based on a change of one dominant bot to a different bot.

FIG. 13 is a schematic diagram of a computing architecture that includes a template library for different bots, and a selection bot to select appropriate bots for a given user.

FIG. 14 is an example computing architecture for implementing the conversational limbic computing system.

FIG. 15 is a schematic diagram showing different embodiments of user devices in data communication with a conversational limbic computing system.

FIG. 16 is an example embodiment of a Digital Signal Processor (DSP)-based voice synthesizer.

FIG. 17 is an example embodiment of a hardware system used by the DSP-based voice synthesizer.

FIG. 18 is a flow diagram of example executable instructions for building a voice library of a contact of a person with dementia.

FIGS. 19 and 20 are flow diagrams of executable instructions for building mapping of different cognitive time periods of a user to relevant content and then playing that content based on the detected cognitive time period of the user.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the example embodiments described herein. However, it will be understood by those of ordinary skill in the art that the example embodiments described herein may be practiced without these specific details. In other instances, well-known methods, procedures and components have not been described in detail so as not to obscure the example embodiments described herein. Also, the description is not to be considered as limiting the scope of the example embodiments described herein.

It is herein recognized that there is a strong desire for a personalized and cost effective solution to assist people with varying degrees of dementia. This help includes specifically helping and assisting the dementia patient with day to day living activities and social interactions as well as helping, assisting, monitoring, and taking medical actions by family, relatives, caregivers, doctors, and other health care providers.

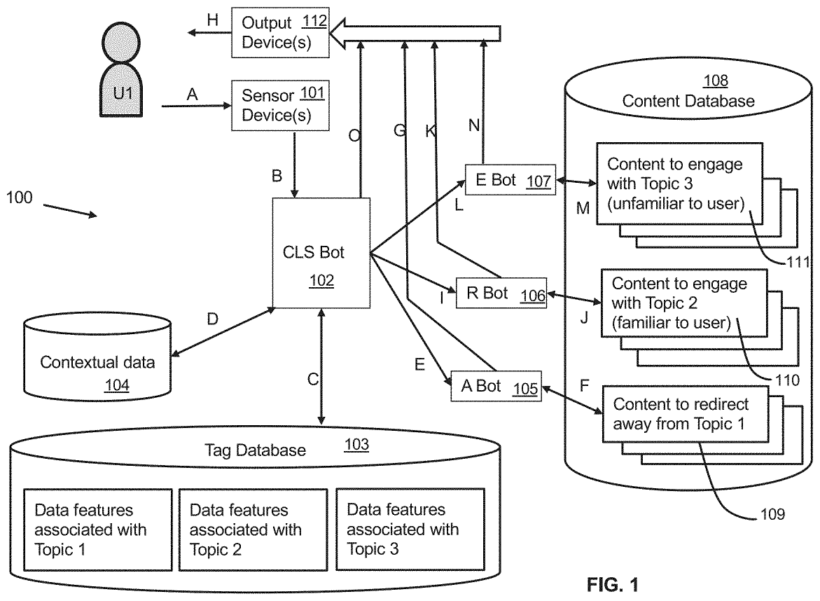

Turning to FIG. 1, software components of a conversational limbic computing system 100 are shown, which include the components 102, 103, 104, 105, 106, 107, 108. One or more sensor devices 101 and one or more output devices 112 receive and transmit data between a user U1 and the conversational limbic computing system 100.

In particular, the user U1 is monitored or tracked by one or more sensor devices 101 (operation A). For example, the one or more sensors include: one or more microphones, one or more cameras, one or more acclerometers, one or more gyroscopes, one or more biometric sensors, one or more brain signal sensors, one or more nerve signal sensors, one or more muscle signal sensors, or a combination thereof. The one or more sensors can be positioned at a distance from the user U1, or can be positioned on the user U1 as a wearable, or a combination thereof in the case of multiple sensors. In some embodiments, the user's behavior is detected by what they say to the computing system 100. In some other embodiments, their behavior is detected by what they think or what they gesture, or both, as detected by the sensor device(s) 1010.

At operation B, the collected user data from the sensor devices (or derivatives of the raw user data) are transmitted to the CLS bot 102. At operations C and D, the CLS bot accesses one or more databases 103, 104 to determine which one of the following bots should be activated: Address bot 105, Reach bot 106 and Expand bot 107.

For example, database 103 includes meta data and data features associated with Topic 1; meta data and data features associated with Topic 2; and meta data and data features associated with Topic 3. The CLS uses the data features to characterize the behavioral state of the user, and if the user's comments relate to Topic 1, Topic 2 or Topic 3.

Topic 1 includes subtopics that are related to fear, uncertainty, depression and agitation. The computing system herein serves a media content package to redirect a user from thinking about Topic 1.

Topic 2 includes subtopics that are neutral or positive, and that are familiar to a user. For example, subtopics could include a hobby, a past vacation place, a favorite song, etc.

Topic 3 includes subtopics that are neutral or positive, and that are unfamiliar to a user. For example, subtopics could include a new skill, a new hobby, new academic area of study, a new book, a new song, etc.

The contextual data 104 include historical data about the user U1 and other users. For example, contextual data includes past behavioral scores or characterizations.

The CLS bot 102 activates one of the Address bot (herein called the A bot), the Reach bot (herein called the R bot), and the Expand bot (herein called the E bot) based on the determined present behavior, or predicted future behavior, or both, of the user.

It will be appreciated that the term “bot” is known in computing machinery and intelligence to mean a software robot or a software agent. The bots described herein have artificial intelligence.

In an example embodiment, the A bot 105 is activated by the CLS bot (operation E). The A bot then obtains content form a content database 108 (operation F). In particular, the A bot obtains content that has been identified to redirect the user away from Topic 1. The A bot (in operation G) then serves a media content package, which includes the obtained content, to the one or more output devices 112, and these one or more output devices provide the media content package to the user U1 (operation H). In an example embodiment, the one or more output devices include a display screen, an audio speaker, a multimedia projector, and a human interface device that allows the user to hear, feel or see the media content.

In an example embodiment, the R bot 106 is activated by the CLS bot (operation I). The R bot then obtains content form a content database 108 (operation J). In particular, the R bot obtains content that has been identified to engage the user with Topic 2. The R bot (in operation K) then serves a media content package, which includes the obtained content, to the one or more output devices 112, and these one or more output devices provide the media content package to the user U1 (operation H).

In an example embodiment, the E bot 107 is activated by the CLS bot (operation L). The E bot then obtains content form a content database 108 (operation M). In particular, the E bot obtains content that has been identified to engage the user with Topic 3. The E bot (in operation N) then serves a media content package, which includes the obtained content, to the one or more output devices 112, and these one or more output devices provide the media content package to the user U1 (operation H).

In an example embodiment, the one or more sensor devices 101 detect one or more of: the voice of the user, the words of the user, the facial expression of the user, the pose of the user's body, the heart rate of the user, the temperature of the user, and brain signals of the user.

In an example embodiment, the CLS bot responds when the user has been detected to not move or speak for a certain amount of time. In an example embodiment, the CLS bot responds when the user says certain phrases or words. In an example embodiment, the CLS bot responds based on readings from the one or more sensor devices.

It will be appreciated that the CLS bot, the A bot, the R bot and the E bot reside on one or more server machines, such as cloud servers. In some other example embodiments, corresponding parts of the CLS bot, the A bot, the R bot and the E bot reside locally on the user's device.

The computing system described herein serves many users. In other words, the computing system herein connects to many sensor devices and output devices, which respectively correspond to many users. It will also be appreciated that each user will have their own corresponding CLS bot, A bot, R bot and E bot that are personalized for themselves.

The conversational limbic system model, which, in an example embodiment, is an operating system kernel, incorporates three levels of intelligence and integration among the levels: Address, Reach, and Expand (A.R.E. model). Each of these levels correlate to one or more levels in a psychological model, an example of one being Maslow's Hierarchy of Needs model. We reference Maslow's classic model because it lays out and explains human social needs in a well-known, established, and prioritized fashion. For example, a person is not concerned about self-esteem or self-actualization experiences and wisdom if that person does not have basic shelter, food, and safety needs already met. As a person's cognitive skills and memory degrade, this leads to increased levels of fear, uncertainty, doubt and agitation because they cannot remember. For example, they cannot remember if they have a safe place to stay, where they are, when they will have their next meal, who they are, or have fear of solitude or loneliness because they do not remember their own family and friends. These problems and concerns are shown in Maslow's hierarchy.

As cognitive skills and memory degrades, a person begins to no longer recall his or her prior accomplishments, capabilities and self-identity. A person may no longer perform activities that build and reinforce pride of work or self-accomplishment, and no longer have the cognition to understand their own potential. Esteem needs and self-actualization needs fade away and are unfortunately replaced with fear, uncertainty, depression needs concerning loneliness, safety, food, and shelter.

A person's needs, like belonging, safety and physiological needs, reveal themselves, in part, by their moods such as sad or agitated moods. A person expresses their sad or agitated moods through their oral comments, facial expressions, level of social engagement, and gestures. Examples include, “I want to go home” is a sad mood, “I don't like you” is an agitated mood, and regularly participation in board games reflects a happy engaged with the world, social mood. The CLS bot tracks this and determines to activate the A bot. In other detected behaviors or moods, the CLS bot activates the R bot or E bot.

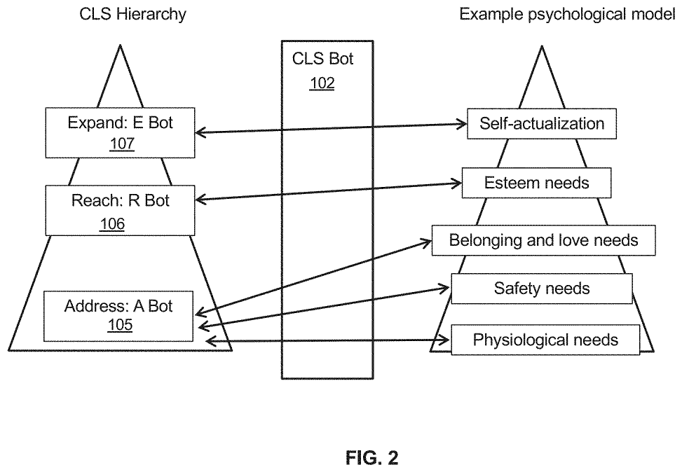

Turning to FIG. 2, the CLS bot 102 maps different levels of a psychological model (e.g. Maslow's hierarchy or some other model) to one or more of the A bot 105, R bot 106, and E bot 107. For example, if the CLS bot detects that a person needs their physiological needs, safety needs, and belonging and love needs to be met, then the CLS bot activates the A bot. If the CLS bot detects that a person needs their esteem needs to be met, then the CLS bot activates the R bot. If the CLS bot detects that a person needs their self-actualization needs to be met, then the CLS bot activates the E bot.

In an example embodiment, when a person is focused on psychological and love needs, safety needs, or psychological needs (or a combination thereof), the CLS bot activates the A bot at a higher number of times and activates the R bot at a lower number of times. For example, within a day, the A bot is activated 40 times and the R bot is activated 10 times. In other words, the A bot is dominant.

As the person progresses to focus more on esteem needs, the CLS bot activates the R bot at a higher number of times relative to the other bots. For example, within a day, the A bot is activated 18 times, the R bot is activated 30 times, and the E bot is activated 2 times. In other words, the R bot is dominant.

As the person progresses even further to focus on esteem needs, the CLS bot gradually increases the number of times of activating the E bot. For example, within a day, the A bot is activated 10 times, the R bot is activated 30 times, and the E bot is activated 10 times.

As the person progresses to focus more on self-actualization needs, the CLS bot activates the E bot at a higher number of times relative to the other bots. For example, within a day, the A bot is activated 5 times, the R bot is activated 15 times, and the E bot is activated 30 times.

In other words, within a given time period (e.g. a week, a day, a part of a day, or an hour), the CLS bot can gradually increase or decrease the number of times a given A bot, R bot or E bot is activated. Furthermore, within a given time period, the blend or composition of the number of times each one of the A bot, R bot and E bot are activated within a given time period can be adjusted between successive time periods.

In an example embodiment, the CLS bot reacts to the behaviors presently detected of a person.

In another example embodiment, the CLS bot reacts to the behaviors presently detected of a person, and taking into account previous behaviors (e.g. historical behaviors of the person to date). In other words, the previous behaviors of the person weight or modify the currently detected behaviors of the person.

In another example embodiment, the CLS bot uses the historical behaviors of the person to date to predict the current behavioral state of the person.

In another example embodiment, the CLS bot uses the historical behaviors of the person to date to predict the current behavioral state of the person.

In another example embodiment, the CLS bot uses the historical behaviors of the person to date to predict the future behavioral state of the person.

Based on the determined behavioral state of the person, the CLS bot then activates one or more of the A bot, R bot and E bot within a given time period.

Address: First Order of CLS Processing

The CLS bot first works with the loved one, family members, and caregivers to address a person's physiological, safety and belonging needs. In particular, the computing system recognizes the fear, uncertainty, depression and agitation induced repetitive questions and provides answers that redirect the person's mood to a happy mood. The CLS bot executes and operationalizes first order, “Address” issues by providing on demand media content that that repetitively answer a person's questions and repetitively, but uniquely, redirect a loved one's sad or agitated mood to a happy mood so that the caregiver and family members can minimize and eventually not have to respond to the loved one's repetitive F.U.D. sad or agitated states. Hence, the Address bot addresses the most labor intensive, frustrating, and repetitive areas that family members and caregivers currently perform and that consequently and directly lead to burnout, resignations and increased staff turnover.

Overtime the CLS system can detect (through natural language speech processing, machine vision processing, IoT devices, and manual input from family members and caregivers and doctors) and recommend supplementing the Address personalized ads with “Reach” personalized ads because the loved one no longer has as many FUDA induced questions and induced sad or agitated moods and has begun showing capacity to move up to next level of engagement with the world, Maslow's esteem needs level, which correlates with the CLS Reach level, the second order of CLS processing.

Executing and operationalizing Address level personalized ads does not preclude the CLS system from simultaneously executing and operationalizing both Reach and Expand personalized media content packages. Each level, Address, Reach, and Expand intelligence levels and corresponding media content packages can run standalone or can execute in any mixed fashion. AI, machine learning, data algos, and input from family members, caregivers, and doctors can adjust the ads, content, frequency, and duration for within each level (Address, Reach, and Expand) as well as the media content packages and content mixed across the Address, Reach, and Expand levels. For example, showing and reinforcing Address media content packages can run simultaneously with Reach media content packages to reinforce anti-FUDA confidence as the user transitions from the Address level to the Reach level. This process can also occur if the user begins transitioning from the Reach level to the Expand level. In this latter situation, Address media content packages and Reach media content packages can still be presented to the user for reinforcement and “flashing” their memory as the user begins transitioning to the Expand, self-realization level. AI, machine learning, data science, and input from family and caregivers manage the programmatic media content packages being served to the user.

Reach: Second Order of CLS Processing

In an example aspect, the Reach bot helps to “prime” and catalyze the user's memory to recall and to encourage the loved one to engage with the world by showing personalized media content packages of themselves doing former hobbies, interests, and activities. The Reach bot uses look-a-like algos that search and find other similar people in age and ethnicity performing these similar hobbies, interests and activities. The intent is to show these personalized media content packages to users so that they may think to themselves, “If they can do this, then I can do this”. In some example embodiments, these media content packages, with content related to Topic 2, remind a user of their interests, and encourage the user, through social pressure watching other people of the same age and ethnicity, that there is no reason why the loved one cannot do this hobby, interest, and activity themselves. In some example embodiments, the conversational limbic computing system is showing and telling the user with dementia all the reasons why they can do this hobby, interest and activity and removing any reasons or mental barriers why they cannot do these activities.

It is herein theorized that the more the user participates or even recalls and socializes around these hobbies, interests, and activities, then the more the loved one stays engaged with the world throughout the day and the less sad or agitated the loved one becomes. It is herein recognized that not all users will be able to move successfully up to and sustain in the Reach level, but it is herein theorized that these media content packages provide a strong and personal incentive for a loved one to think about and possibly do these events as opposed to being concerned with fear, uncertainty, depression and agitation, which could be good for the user's wellbeing and may reduce stress, burnout, and agitation for family members and caregivers. These results also provide insights to doctors, who are following their patients and the doctors' ability to make more intelligent medical management decisions.

The intent, in these Reach examples, is to help the user become engaged with the world through activities that they can still perform. These examples include socializing about current events, playing games, sing-a-longs, making crafts, painting, etc. that the user used to do and liked to do. Completing a craft, winning a game, painting etc. provides the user with a sense of accomplishment. The Reach bot's intelligence level is merely a system to prime the user's mental pump and encourage the loved one to pick up the craft, game, and so forth and build and reinforce Maslow's esteem needs.

Expand: Third Order of CLS Processing

In an example embodiment, the Expand bot helps “prime” and catalyze a user to remember, and to encourage the user to engage more with the world by showing personalized media content packages of people of the same age and ethnicity doing new and different hobbies, interests, and activities (e.g. unfamiliar to the user). Using look-a-like algos, the Expand bot intelligently searches and finds similar people in age and ethnicity with similar hobbies, interests, and activities and presents personalized media content packages of these people doing activities that the user is not doing. For example, the Expand bot show that people like you (i.e. the user) also like doing these hobbies, interests, and activities. These personalized look-alike media content packages may help a user to achieve self-actualization like thinking.

Personalized Media Content

The purpose of personalized media content is to help a specific person recall their own recent and historical memories, events, activities, and experiences. Furthermore, these media content servings help the person recall who they are (e.g. self-identity) and who are their family members and friends. These media content packages can include personal pictures, videos, familiar voices (e.g. of friends, family and caregivers), and familiar sounds (e.g. the sound of an ocean, a campfire, a river, etc.). These personal images and sounds intend to assist and catalyst the loved one's memory to help them recall people, places, events, and experiences in their life so that the loved one can take baby steps towards reducing Topic 1 thoughts (e.g. fear, uncertainty, depression, agitation, etc.) and ultimately take steps toward engaging with the world through familiar topics (e.g. Topic 2 content like former hobbies, interests, activities, etc.) and unfamiliar topics (e.g. Topic 3 content like new hobbies, interests, activities, etc.).

Each of the Address bot, Reach bot and Expand bot has its own personalized media content for a given person. The following sections describe the process and steps to execute and operationalize each bot.

Example of Address Bot Process

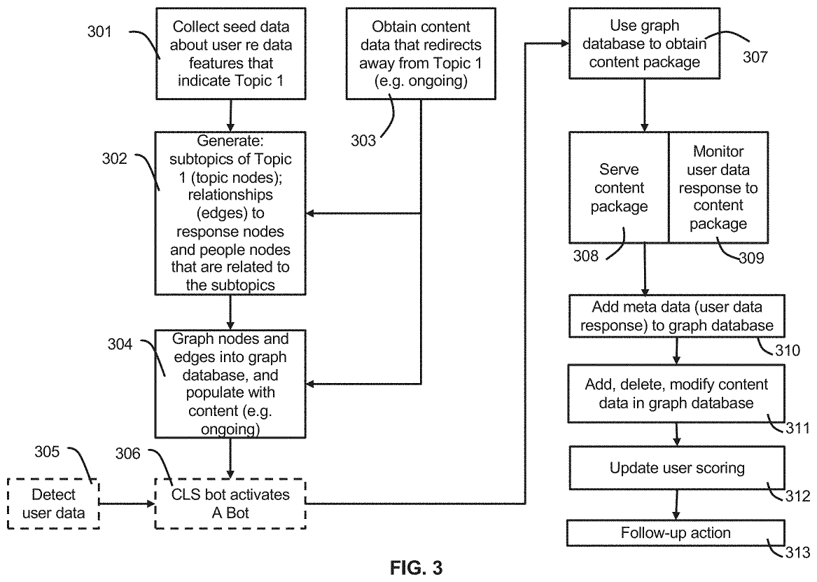

Turning to FIG. 3, example executable instructions are performed by the Address bot.

Block 301: Collect seed data about a user regarding data features that indicate Topic 1. For example, family members, friends, and caregivers provide frequently asked questions (FAQs), utterances, etc. that signals when a user is sad, fearful, uncertain, or agitated.

Block 302: Generate the following: subtopics of Topic 1 (topic nodes); and relationships (edges) to response nodes and to people nodes that are related to the subtopics. In particular, the people in the corresponding people nodes are those people that can help divert a user away from suptopics of Topic 1. For example, a user is uncertain about whether the bills are paid (e.g. payment of bills is a subtopic node) and a user's son is responsible for answering that question (e.g. the user's son is a person node related to the payment-of-bills subtopic node). An answer or response to a subtopic (e.g. a response node) is also mapped to the subtopic node. In an example embodiment, the voice of the person is used to deliver an audio response. For example, a payment-of-bills subtopic node is related to a son node and a response node. The response node includes, for example, the son's voice being used to deliver the message “Don't worry, I have paid the bills already for this month and we have enough money in the bank”.

For example, using the seed data, the computing system identifies and tags fear, uncertainty, depression and agitation (herein called FUDA) topics and issues of the user, which become subtopic nodes and the relationships (e.g. edges) to people (e.g. people nodes) who normally “own and answer” (a response is a node) the user's comments, FAQs, behavioral state. Examples of tags include: sad, agitated, happy, etc. Other tags that label a person's behavior or mood can be used.

Block 303: Obtain content data that redirects the user away from Topic 1. For example, this process is ongoing as more content from family and friends of the user becomes available.

This process of obtaining content data includes, for example, a family member or friend uploading pictures, videos, audio clips, and sounds that would redirect the user from thinking or dwelling on Topic 1 (or subtopics of Topic 1). The process then includes executing look-a-like internet searches for pictures, videos, audio clips, etc. Therefore, even if the family and friends do not have a lot of content about the user, the A bot can find relevant content to redirect the user away from Topic 1. In an example aspect, these look-a-like pictures, videos, audio clips, etc. are used to supplement and change up the previous media content packages with family and friends pictures, videos, audio, etc. In other words, there can be a blend of public content and personal content.

Block 304: Graph nodes and edges into graph database, and populate with content. For example, the content obtained in block 303 is used to populate the graph database into response nodes. For example, the obtained content related to an audio clip of a son saying “Don't worry, I have paid the bills already for this month and we have enough money in the bank”. This audio content would be stored in a node that is related to the payment-of-bills subtopic. In other words, the obtained video content, audio content, image content, etc. is used to populate response nodes in the graph database.

In an example embodiment, the response nodes store the media content itself. In another example embodiment, the response nodes store data links (e.g. URLs) to where the media content is located on a third-party web platform, or on an internal server, or on a local memory device belonging to the user.

In another example embodiment, the response nodes store a combination of the media content portions stored in different places. For example, a first portion of the media content includes an audio introduction stored on the server of the conversational limbic computing system and a second portion of the media content is accessed by a URL that links to a YouTube video, or a video on some other 3^{rd} party platform.

In an example aspect, for each topic/issue (subtopic node), provide a response for the loved one (response node):

1. use pre-recorded answers by a familiar voice (family member, caregiver)
2. use a synthesized voice (accurately reflecting the family member or caregivers' voices) answer
3. use pictures, videos, audio clips, FAQ responses that answer the loved one frequently asked question
4. use a combination of both a familiar voice and a picture/video so that both visual and audio help reinforce the answer to the loved one's question
5. use AI and machine learning to determine which answers by the right person had a higher success rate by reducing the loved one's specific question
6. add this meta data to the graph database

In a preferred aspect, although not necessarily, the response node is associated with a person node (e.g. a family member of the user, or someone else that is familiar to the user). The voice of the person is used to deliver the audio content, for example. Furthermore, alert messages regarding usage of the response node are transmitted to the person's contact information (e.g. email address, phone number for text messaging or calling, video conferencing account, instant messaging account, etc.) associated with the person node.

As more data is acquired over time, add metadata to the nodes and relationships and include what answers, voices, content (e.g. audio, picture, video, etc.) are effective or not effective for future media servings.

Blocks 301 to 304 relate to setting up the content for the A bot.

Block 305: the computing system detects user data.

Bock 306: the CLS bot activates the A bot. It will be appreciated that the CLS bot can pro-actively activate the A bot even without detecting and responding to user data (e.g. using a set schedule, or using prediction, etc.).

In an example aspect, the CLS bot uses a microphone (e.g. a sensor) to detect what a user is saying: questions, utterances, etc. The following steps occur:
1. Perform real time speech to text processing on loved ones questions and utterances
2. Perform real time natural language processing (NLP) on loved ones questions and utterances
3. Perform real time data science computations on what was said (e.g. the text derived from NLP) to classify the mood associated with the detected question, utterance, etc.

It will be appreciated that other data from other sensors (e.g. camera sensors, biometric sensors, human body sensors, brain sensors, etc.) are processed in a different way to assess or classify the user's behavior or mood.

Block 307: Use the graph database to obtain content package.

For example, the graph database is used to quickly search, identify, and select the right FAQ answer(s) from the appropriate person's voice (e.g. the voice of a son or someone else who is familiar to the user). Multiple answer(s) can be used to respond to a question or an utterance, or some other detected user data, which can reside in the graph database. In other words, multiple response nodes can be mapped to a subtopic node. Conversely, multiple subtopic nodes can be mapped to a response node. This preempts the user from ignoring the answer, even though correct, because it is exactly the same answer he/she has heard previously and can remember that exact response.

In another example aspect of block 307, the A bot uses the graph database to quickly search, identify, and select the right audio clips, pictures, videos, slide shows, background sounds, music (or any combination of the aforementioned) if a user's utterance or gesture or facial expression, or some other detected user data feature indicates that the user exhibits Topic 1 content or behaviors (e.g. fear, uncertainty, depression, agitation, etc.).

In a further example aspect, the graph database stores metadata on which pictures, videos, audio clips, slideshows, background sounds, music were previously successful or were not successful in redirecting the user away from focusing on Topic 1. This determination of a successful or unsuccessful outcome can be determined by detecting and analysing, using machine learning, the user's response after serving the media content response (e.g. detecting what the user says, their facial expressions, their body pose, etc.).

In a further example aspect of block 307, the computing system can pick and present different pictures, videos, audio clips, slide shows, background sounds, and music and play these in different sequences and/or put some multimedia in and leave some multimedia out in order to present a media content package that looks new and never seen before, but has the same overall goal to redirect the loved one from a sad or agitated state to a happy state.

In other words, the media content package served to a user can be formed on-the-fly from different media content, or selected from different media content, even if the user is expressing the same behavior.

Block 308: The A bot serves the media content to the user, which is outputted via the user's output device(s) 112.

Block 309: While the content package is being served and after the content package has been served, in an example embodiment, the A bot monitors the user data response to the content package. The user response data can be detected by using microphones, machine vision cameras, body sensors, brain signal sensors, etc.

Block 310: Add meta data (e.g. the user data response) to the graph database. Examples of meta data added to the graph database include: positive, neutral, or negative response by loved ones regarding picture(s), slideshow(s), video(s), music clip(s), background sound(s); responses in the form of oral responses, gestures, facial expressions, body signals, brain signals, etc.; number of times an audio, picture, video, slideshow, background sounds, music, etc. has been played; date and time stamp when audio, picture, video, slideshow, background sounds, music, etc. has been played; and location/GPS note where the audio, picture, video, slideshow, background sounds, music, etc. has been played.

Block 311: The user data response is used as feedback to add, delete and modify the media content stored in the response nodes.

For example, the oral responses are processed with look-a-like algorithms to find and identify new pictures, videos, slideshows, audio clips, background sounds, etc. that could help create future mood changing media content packages.

In another example, machine learning and data science are used against the user meta data (see block 310) to surface and identify positive and negative patterns. In some example embodiments, if the user's reaction to a given media content package is negative, then media content that forms the given media content package is added to a black list associated with the user so that the media content is not served again. In some example embodiment, if the user reacts positively to a given media content package, then that the media content that formed that given media content package is weighted higher so that it can be served again to the user.

In another example, machine learning (ML), including artificial intelligence (AI), is used to track, monitor, predict, and present media content packages for future interactions with the user, in order to further reduce fear, uncertainty, depression or agitation of the user.

Below are some example embodiments of using AI and ML to determine how frequent a specific media content package should be served by the A bot. It will be appreciated that one or more of the following computational approaches can be used to automatically adjust the frequency of serving the specific media content package.
1. Play a specific “Address” media content package every N times/day or every N days based on ML calculation, which is played in response to a specific subtopic under Topic 1 is served (e.g. subtopic is “I want to go home”)
2. Track, monitor and analyze, using ML, if the specific media content package reduces a number of instances the specific subtopic under Topic 1 is detected (e.g. the number of times the user says “I want to go home”)
3. Track, monitor, and analyze if the specific media content package reduces non-specific or general sadness or agitation using ML (e.g. detect decreased overall number of times of sad or agitated events over a duration . . . a week, a month, etc.)
4. Track, monitor, and analyze if the specific media content package successfully redirects loved one from sad or agitated to happy
5. Track, monitor, and analyze if the user becomes more engaged in Reach activities or Reach media content packages, or both
6. Track, monitor, and analyze if the user reduces FAQs under Topic 1 because the user is more engaged with Reach media content packages or Reach activities, or both
7. Track, monitor, and analyze if family members and caregivers burn out, resignation and turnover rate is reduced as a result of running the specific media content package

It will be appreciated that other metrics and statistics can be used to determine the frequency of serving a given Address media content package.

Block 312: Update user scoring. In particular, one or more behavioral scores, or memory scores, or psychological scores are used to track a person's cognitive state over time. The detected user data that triggers the CLS bot to activate the A bot, or the user's response to the served media content package, or both, are used to update the user score(s).

Block 313: The A bot executes one or more follow-up actions. For example, the A bot could send an alert message to another party if the Address media content package was served over X times in a given time period.

In another example of a follow-up action, the A bot or the CLS bot could also send commands to other IoT devices. For example, if the psychological scoring indicates that the user's cognitive abilities are currently at a lower level, then the commands are used to activate assistive Internet-of-Things (IoT) devices (e.g. a mechanism to open/close a door; a mechanism to flush the toilet; a mechanism to control the stove; etc.). Conversely, if the psychological scoring indicates that the user's cognitive abilities are currently at a higher level, then the commands are used to deactivate the assistive Internet-of-Things (IoT) devices.

Example of Reach Bot Process

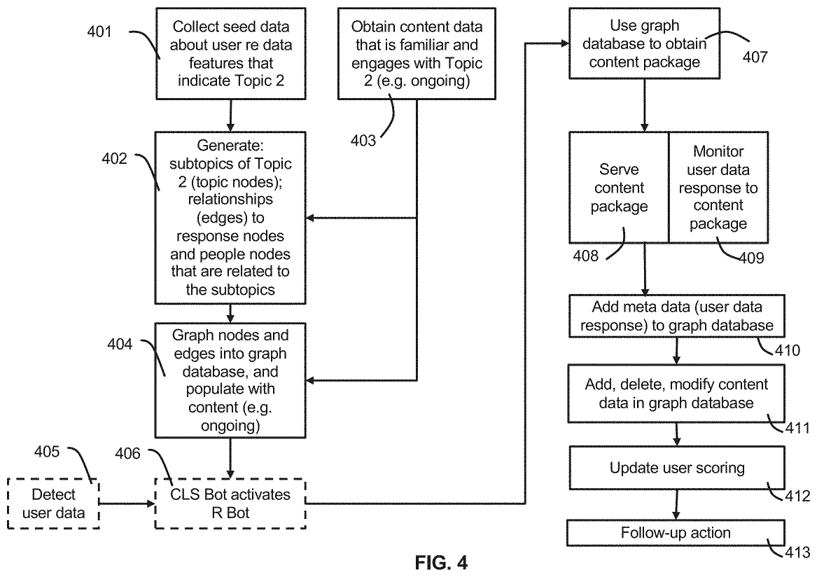

Turning to FIG. 4, example executable instructions are performed by the Reach bot. The process is similar to the Address bot, but the goal is to engage the user with Topic 2, which includes content that is familiar to the user and is psychologically or behaviorally positive.

Block 401: Collect seed data about user regarding data features that indicate Topic 2. For example, family members, friends and caregivers of the user provide FAQs, utterances, etc. about the user's familiar hobbies, interests, activities, music, vacations, foods, sports, etc. This operation can also include people uploading pictures, videos, audio clips, background sounds, words describing interests, hobbies, activities, etc. that the user enjoys in recent times or enjoyed in the past (e.g. when they were in a different stage in life).

Block 402: Generate subtopics of Topic 2 (subtopic nodes), and generate relationships (edges) to response nodes and people nodes that are related to the subtopics. Subtopic nodes under Topic 2 include, for example, hobbies, interests, activities, music, vacations, foods, sports, etc. that are familiar and liked by the user. People nodes represent one or more people that are involved with each given subtopic. For example, a daughter of the user is a person node that is associated with a Greece-vacation subtopic node. In another example, a grandchild of the user is a person node that is associated with a grandkids subtopic node. Response nodes represent the media content that is served to the user when a given subtopic node is activated.

Block 403: Obtain content data that is familiar to the user and engages the user with Topic 2 (e.g. ongoing). This includes people uploading pictures, videos, audio clips, background sounds, words describing interests, hobbies, activities, etc. that the user enjoys in recent times or enjoyed in the past (e.g. when they were in a different stage in life). This operation also includes, for example, using the seed content and the seed data about the user's interests, hobbies, music, vacation places, etc. to perform a look-a-like search for pictures, videos, and audio clips on the Internet. This media content found on the Internet is used to supplement and expand the amount of Topic 2 related media content that is accessible to the R bot. This media content found on the Internet can be combined or mixed with the seed content provided by family members and friends of the user.

The media content can also be obtained by recording the user saying or doing something that relates to a subtopic under Topic 2. In other words, media content can include a recording of the user saying or doing something or both. In another example, the R bot creates a synthesized replication of the user saying or doing something, or both. For example, a recording of the user says “I like baking pies.”, and then a synthesized voice of a family member then repeats in an alternate form “You like baking pies?”. Mimicking or repeating the user in a familiar voice can help to reaffirm the positive thoughts and behaviors of the user.

It will be appreciated that the process of obtaining media content is ongoing since family members and friends may add new Reach media content over time. Furthermore, the R bot continues to conduct new searches for look-a-like content.

Block 404: Graph nodes and edges into graph database, and populate the response nodes with the obtained media content.

An example of a response (e.g. a proactive response or response to user's action/utterance/question) is: “Hi mom, remember when you used to this art work?”. This audio response is associated with a person node being the daughter, and is said using the daughter′ voice. The response also include pictures of the mom's artwork, crafts, etc., which are displayed to the mom.

Another example of a response is: “Would you like me to work with you on this (painting, craft, activity, etc)?. This audio response is associated with a person node that is familiar to the user, and said in that person's voice.

Getting a “yes” or the like from the user to these example questions activates further media content to keep the conversation moving forward.

Populating the response nodes with the obtained media content includes, for example, one or more of the following: using pre-recorded answers by a familiar voice (family member, friend, caregiver); using a computer synthesized voice (accurately reflecting the family member or caregivers' voices) answer; using a familiar voice with visual content (e.g. a picture or a video) so that both visual and audio help reinforce prior hobby, interest, activity, etc.; using media content obtained from the Internet; using media content that is a recording or synthesized replication/mimic of the user saying or doing something or both; and using a combination of different types of media content.

In an example embodiment, the response nodes store the media content itself. In another example embodiment, the response nodes store data links (e.g. URLs) to where the media content is located on a third-party web platform, or on an internal server, or on a local memory device belonging to the user.

In another example embodiment, the response nodes store a combination of the media content portions stored in different places. For example, a first portion of the media content includes an audio introduction stored on the server of the conversational limbic computing system and a second portion of the media content is accessed by a URL that links to a YouTube video, or a video on some other 3^{rd} party platform.

Block 405: Detect user data. For example, the input devices are used to detect the current behavior of the user, what they said, what they did, how they look (e.g. facial expression, their body pose, etc.).

Block 406: CLS Bot activates R Bot. In an example embodiment, the CLS bot activates the R bot in response to detecting the user data. For example, if the user data is related to a subtopic under Topic 2, then the CLS bot activates the R bot. In another example, the CLS bot proactively activates the R bot.

Block 407: Use graph database to obtain a media content package. For example, the R bot uses the graph database to quickly search, identify, and select the right audio clips, pictures, videos, slide shows, background sounds, music (or any combination of the aforementioned) to select an existing media content package, or to dynamically form a new media content package.

Block 408: The R bot serves the obtained media content package to the user, which is transmitted to the user via one or more output devices.

In an example embodiment, the media content package or packages are served to the user based on a predetermined schedule for the user. In an example embodiment, the predetermined schedule is generated or adjusted at block 407, when the R bot is forming the one or more media content packages.

Block 409: The R bot monitors user data response to the media content package while or after it is served to the user. The user response data can be detected by using microphones, machine vision cameras, body sensors, brain signal sensors, etc.

Block 410: Add meta data (e.g. user data response) to the graph database. Examples of meta data added to the graph database include: positive, neutral, or negative response by the user regarding picture(s), slideshow(s), video(s), music clip(s), background sound(s); responses in the form of oral responses, gestures, facial expressions, eye movement, body pose, body signals, brain signals, etc.; number of times an audio, picture, video, slideshow, background sounds, music, etc. has been played; date and time stamp when audio, picture, video, slideshow, background sounds, music, etc. has been played; and location/GPS note where the audio, picture, video, slideshow, background sounds, music, etc. has been played.

Block 411: Add, delete, modify content data in graph database depending on the engagement or response of the user with the served media content.

For example, the oral responses from the user are processed with look-a-like algorithms to find and identify new pictures, videos, slideshows, audio clips, background sounds, etc. that could help create future Reach media content packages. For example, if media content package includes video of baking a pie, and the user responds while watching to video by saying “I like to make my own crust”, then videos of making pie crust from search are obtained and populated in the graph database for future media content packages.

In another example, machine learning and data science are used against the user meta data (see block 410) to surface and identify positive and negative patterns. In other words, if a user positively responds to the served media content package, then the media content in the package has a higher re-use weighting and will be more likely used again. If a user negatively responds to the served media content package, then the media content in the package has a decreased re-use weighting and will be less likely used again. In some other example embodiments, if the user's reaction to a given media content package is negative, then media content that forms the given media content package is added to a black list associated with the user so that the media content is not served again.

Below are some example embodiments of using AI and ML to determine how frequent a specific media content package should be served by the R bot. It will be appreciated that one or more of the following computational approaches can be used to automatically adjust the frequency of serving the specific media content package.
1. Play a specific “Reach” media content package every N times/day or every N days based on ML calculation, which is played in response to a specific subtopic under Topic 2 is served (e.g. subtopic is “I like baking pies”)
2. Track, monitor and analyze, using ML, if the specific media content package increases a number of instances the specific subtopic under Topic 2 is detected (e.g. the number of times the user says “I like baking pies”)
3. Track, monitor, and analyze if the specific media content package increases positive behaviors using ML (e.g. detect increased overall number of times of happy or engaged events over a duration . . . a week, a month, etc.)
4. Track, monitor, and analyze if the specific media content package successfully engages the user with the specific subtopic (e.g. does the user respond in a positive way to the media content package?)
5. Track, monitor, and analyze if the user becomes more engaged in Reach activities or Reach media content packages, or both
6. Track, monitor, and analyze if the user reduces FAQs under Topic 1 because the user is more engaged with Reach media content packages or Reach activities, or both
7. Track, monitor, and analyze if family members and caregivers burn out, resignation and turnover rate is reduced as a result of running the specific media content package

It will be appreciated that other metrics and statistics can be used to determine the frequency of serving a given Reach media content package.

Block 412: Update user scoring.

Block 413: Execute follow-up action.

Example of Expand Bot Process

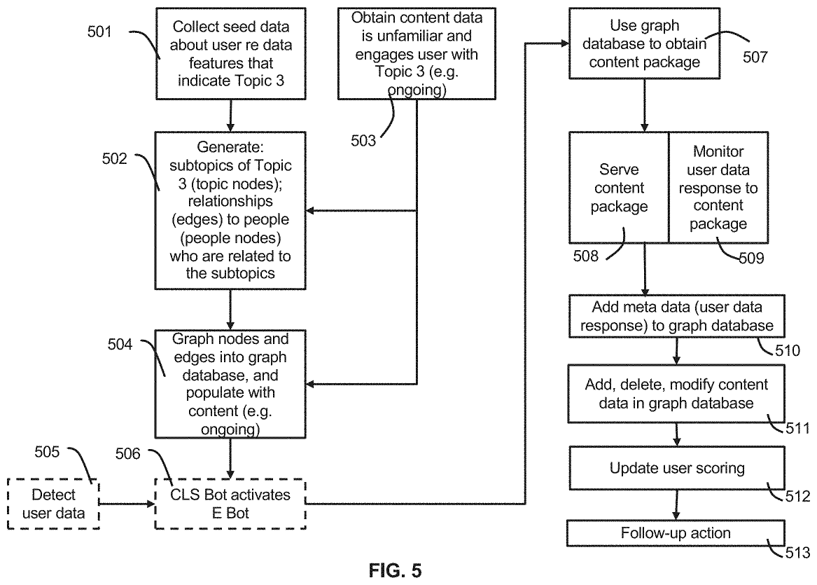

Turning to FIG. 5, example executable instructions are performed by the Expand bot.

Block 501: Collect seed data about user regarding data features that indicate potential subtopics under Topic 3, for which the user is unfamiliar with, but could be of interest to the user.

For example, family members, friends and caregivers of the user provide FAQs, utterances, etc. about the user's familiar hobbies, interests, activities, music, vacations, foods, sports, etc. This operation can also include people uploading pictures, videos, audio clips, background sounds, words describing interests, hobbies, activities, etc. that the user enjoys in recent times or enjoyed in the past (e.g. when they were in a different stage in life). Alternative and unfamiliar hobbies, interests, activities, music, vacations, foods, sports, etc. are then found using this seed data.

The seed data could also include unfamiliar hobbies, interests, activities, music, vacations, foods, sports, etc. that are suggested by family members, caregivers and friends.

Block 502: Generate: subtopics of Topic 3 (subtopic nodes), and relationships (edges) to response nodes and people nodes that are related to the subtopics under Topic 3.

Block 503: Obtain content data is unfamiliar and engages user with Topic 3 (e.g. ongoing).

Block 504: Graph nodes and edges into graph database, and populate with content

Block 505: Detect user data.

Block 506: CLS Bot activates E Bot.

Block 507: Use graph database to obtain content package.

Block 508: Serve content package.

Block 509: Monitor user data response to content package.

Block 510: Add meta data (user data response) to graph database.

Block 511: Add, delete, modify content data in graph database.

Block 512: Update user scoring.

Block 513: Execute follow-up action.

It will be appreciated that the operations in FIG. 5 are very similar to the operations in FIG. 4, but that the media content of the E bot relates to unfamiliar subtopics that engage the user and make the user happy.

Examples of CLS Bot Processes

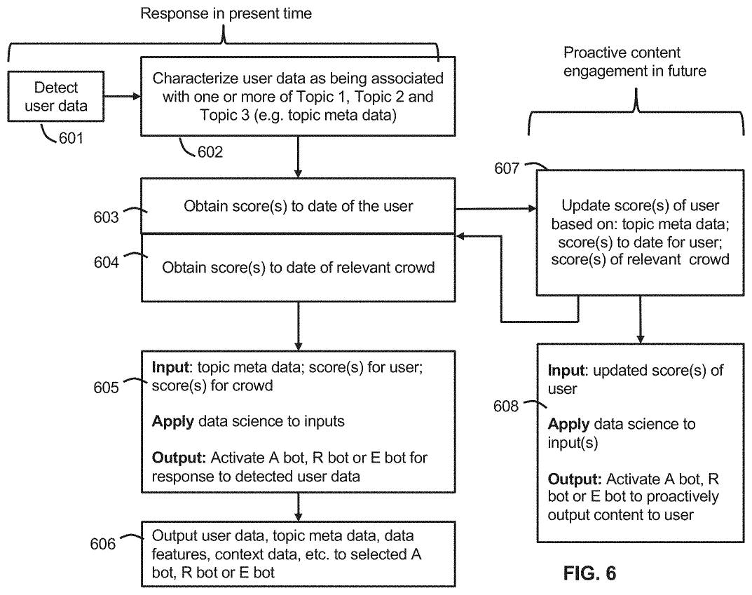

Turning to FIG. 6, an example embodiment of instructions that are executed by the CLS bot is provided. Blocks 601 to 606 represent actions in the present time that are responsive to presently detected user data.

Block 601: The CLS bot detects user data. This data can be derivatives (e.g. like computed data features) of the raw user data obtained by the one or more sensor devices 101.

Block 602: The CLS bot characterizes the user data as being associated with one or more of Topic 1, Topic 2 and Topic 3. For example, this is topic meta data.

In an example embodiment, the characterization is made by analyzing the data features of the detected user data and comparing these data features against the data features stored in the database 103.

In another example embodiment, the detected user data (or derivatives like computed data features) are passed into a neural network, which has been trained to output classifications related to Topic 1, Topic 2 and Topic 3.

Block 603: The CLS bot obtains the user score(s) to date. The user score is, for example, representative of one or more of their behavior, their memory, and their psychological state. For example, these scores are stored in the contextual data 104.

Block 604: Optionally, the CLS bot obtains the score(s) to date of the relevant crowd. In some embodiments, it is desirable to compare the given user's score against the score of others that are similar to the given user.

Block 605: The CLS bot uses the following as input: topic meta data; score(s) for user; and, optionally, score(s) for the crowd. The CLS bot then processes these inputs using data science to determine which bot to activate. In particular, the CLS bot then activates the A bot, the R bot, or the E bot (e.g. the outputted bot as determined by the data science processing) to respond to the detected user data.

In an example embodiment, the CLS bot uses statistical methods to process the inputs and arrive at the output. In another example embodiment, the CLS bot uses neural networks to process the inputs and arrive at the output. In another example embodiment, the CLS bot uses fuzzy logic to process the inputs and arrive at the output. It will be appreciated that other data science methods (including other machine learning computations) can be used to select which bot to activate.

Block 606: The CLS bot also transmits or outputs one or more of the following data components to the selected A bot, R bot or E bot: user data, topic meta data, data features, context data, other derivative data of the raw user data, raw user data, etc.

In another example aspect, the CLS bot uses the detected user data to determine whether to proactively engage the user in the future using one or more of the A bot, R bot and E bot, as per blocks 607 and 608. The blocks occur in parallel or separately from blocks 605 and 606.

Block 607: Following block 603 and, optionally, block 604, the CLS bot updates the score(s) of the user based on: topic meta data; score(s) to date of the user; and (optionally) score(s) of the relevant crowd.

In an example aspect, the updated behavioral score(s) is fed back into the data store so that, in future operations of block 603, the updated behavioral score(s) is/are obtained.

Block 608: The CLS bot inputs the updated score(s) of the user into a data science process. The data science process determines which of the bots (e.g. A bot, R bot, E bot) to proactively activate to serve media content packages to the user.

In another example aspect of block 608, the CLS bot further outputs a future date and time for which the selected bot (e.g. one of the A bot, R bot, E bot) should be activated to serve a media content package to the user.

In some example embodiments, the score(s) explicitly includes historical behavioral data, or memory data, or psychological data. In some other example embodiment, the score(s) implicitly includes historical behavioral data, or memory data or psychological data, or a combination thereof. In another example embodiment of block 608, the input further includes contextual data, which includes historical behavioral data. Therefore, in these examples, the CLS bot uses the user score(s) to predict future behavior of the user, and the CLS bot uses this predicted future behavior to determine which one of the A bot, R bot, E bot should be activated and at what date and time. In an example embodiment, the prediction of future behaviors can be made using artificial intelligence, machine learning or other statistical computations.

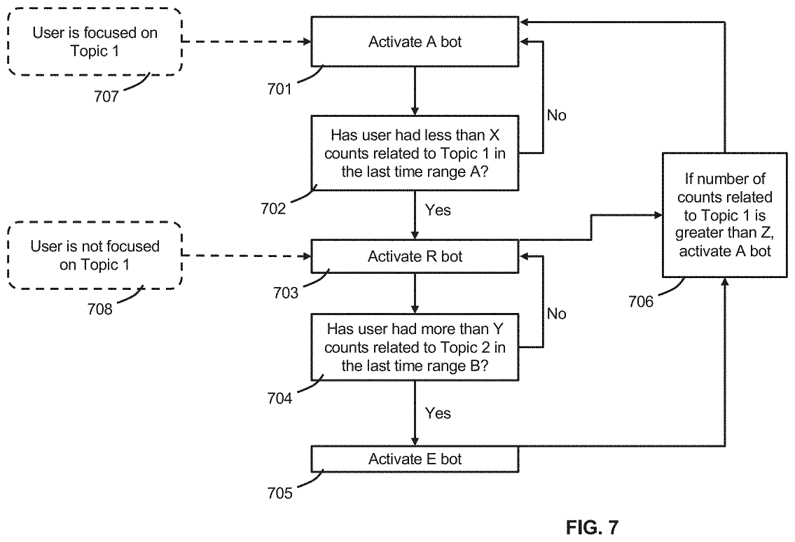

Another example embodiment for instructions that are executable by the CLS bot is shown in FIG. 7.

Block 701: The CLS bot activates the A bot.

Block 702: The CLS bot determines if the user had less than X counts related to Topic 1 in the last time range A. If no, the process returns to block 701 and the A bot continues to be activated. If yes, the process continues to block 703.

Block 703: The CLS bot activates the R bot.

Block 704: The CLS determines if the user had more than Y counts related to Topic 2 in the last time range B. If no, the process returns to block 703 and the R bot continues to be activated. If yes, the process continues to block 705.

Block 705: The CLS activates the E bot.

Block 706: While the R bot is activated or while the E bot is activated, if the CLS bot determines that the number of detected user events/incidents related to Topic 1 is greater than Z, then the CLS bot activates the A bot (going to block 701).

In some example embodiments, there is an initial user characterization process. If, from that characterization process, it is determined that the user is focused on Topic 1 (block 707), the CLS bot first activates the A bot (block 701). If, from that characterization process, it is determined that the user is not focused on Topic 1 (block 708), the CLS bot first activates the R bot (block 703).

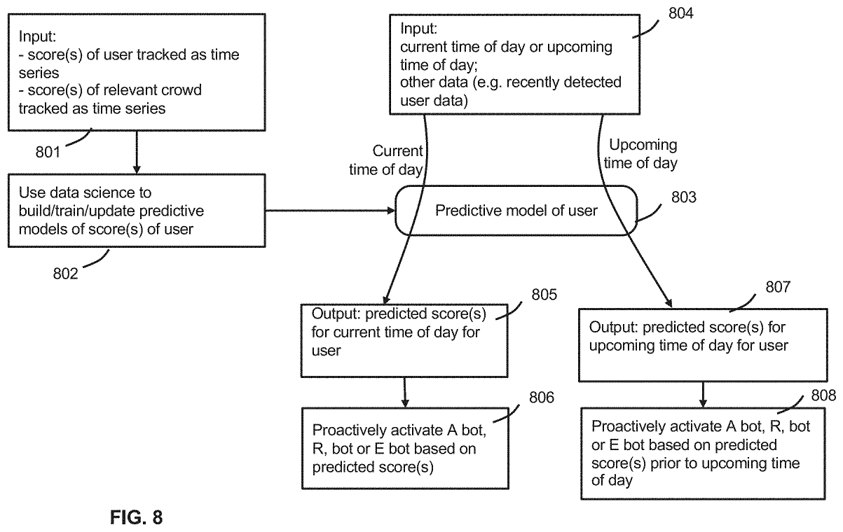

Another example embodiment of instructions, which are executable by the CLS bot, are provided in FIG. 8.

Block 801: The CLS bot obtains, as input, the score(s) of the user tracked as time series (e.g. a behavioral score, or a memory score, or a psychological score). The CLS bot can optionally obtain, as input, score(s) of relevant crowd tracked as time series (e.g. also a behavioral score, or a memory score, or a psychological score).

Block 802: The CLS bot then uses data science to build, train or update predictive model(s) of score(s) of user. In particular, in a first iteration, the CLS bot builds and trains the predictive model(s) of the score(s). In subsequent iterations, the CLS bot uses newer and additional data to update (or retrain) the predictive model(s).

Predictive model(s) 803 of the user's score(s) are outputted from block 802.

After the predictive model(s) 803 of the user has been built, trained, or updated, or a combination thereof, then the following computations take place.

Block 804: The CLS bot obtains as input: the current time of day or an upcoming time of day; and other data (e.g. recently detected user data). These inputs are inputted into the predictive model(s) 803.

In an example embodiment where the current time of day is inputted into the predictive model(s) 803, blocks 805 and 806 are executed.

Block 805: The predictive model(s) 803 output the predicted score(s) for the current time of day for the user.

Block 806: The CLS bot then proactively activates the A bot, R, bot or E bot based on the predicted score(s).

In another example embodiment where the upcoming time of day is inputted into the predictive model(s) 803, block 807 and 808 are executed.

Block 807: The predictive model(s) 803 output the predicted behavioral score(s) for the given upcoming time of day for the user.

Block 808: The CLS bot then proactively activates the A bot, R, bot or E bot based on predicted behavioral score(s) prior to upcoming time of day. For example, if a CLS bot predicts that the user will be focused on Topic 1 in 2 hours from now, the CLS bot will activate the A bot in advance to prevent the user from thinking about things relate to fear, uncertainty, depression and agitation. More generally, the CLS bot attempts to prevent certain negative behaviors in advance, or attempts to encourage certain positive behaviors in advance, or both.

In an example aspect, the CLS bot also transmits the predicted behavioral score(s) to the activated bot (e.g. one of the A bot, R bot, E bot).

Example Embodiment of Expand Bot Process that Teaches

It is herein recognized that as a user progresses emotionally or behaviorally, they may develop expertise in certain familiar topics (e.g. one or more subtopics of Topic 2). In order to help that user expand their emotional and behavioral levels, one approach is to encourage that user to teach their expertise to others who would be interested in those same familiar topics.

For example, a first woman enjoys and is experienced at painting. A second woman is interested in painting too. The E bot of the first woman automatically encourages the first woman to teach painting and facilitates the generating and transmission of teaching content to the second woman, via the R bot of the second woman. In some scenarios, such as in long term care facilities or nursing homes, the first woman is called an ambassador.

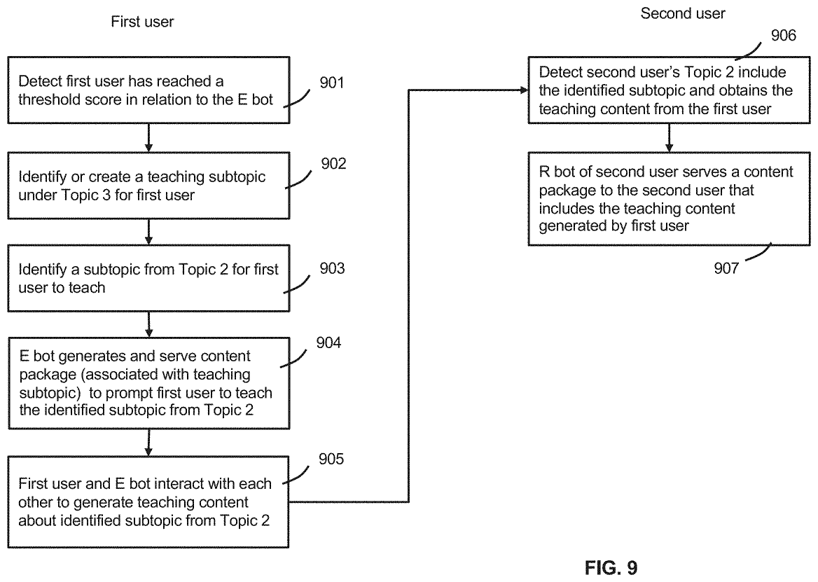

Turning to FIG. 9, example executable instructions are provided for one or more bots of a first user (e.g. blocks 901 to 905), and one or more bots of a second user (e.g. blocks 906 and 907).

For the first user:

Block 901: The CLS bot detects that the first user has reached a threshold user score in relation to the E bot. For example, the CSL bot detects that the first user is positively engaged and is ready to try to expand their behavior by teaching others.

Block 902: The E bot identifies or creates a teaching subtopic under Topic 3 for the first user.

Block 903: The E bot identifies a subtopic from Topic 2 for the first user to teach. For example, this subtopic under Topic 2 could be a hobby, activity or interest that that is very familiar to the first user. For example, the subtopic is painting.

Block 904: The E bot generates and serves a media content package (associated with the teaching subtopic) to prompt the first user to teach the identified subtopic from Topic 2.

Block 905: The first user and the E bot interact with each other to generate teaching content about the identified subtopic from Topic 2. For example, the E bot executes the following operations:
1) Provides a tutorial or some examples, or both, about how to create teaching content using video or audio, or both.
2) Receives a command from the first user to start a recording session.
3) Records the teaching content using video or audio, or both.
4) Receives a command from the first user to end the recording session.
5) Stop recording the teaching content.
6) Reiterate the recording process, or auto edit the recorded teaching content, or both.
7) Output the teaching content.

For the second user:

Block 906: The R bot detects that the second user's Topic 2 includes the identified subtopic of the first user. For example, the second user has subtopic of painting under Topic 2. The R bot of the second user then obtains the teaching content generated by the first user.

Block 907: The R bot of the second user serves a media content package to the second user that includes the teaching content generated by the first user.

In this way, the first user can teach the second user, and this psychologically benefits both users.

Example Embodiments of Computing and Transmitting Status Updates

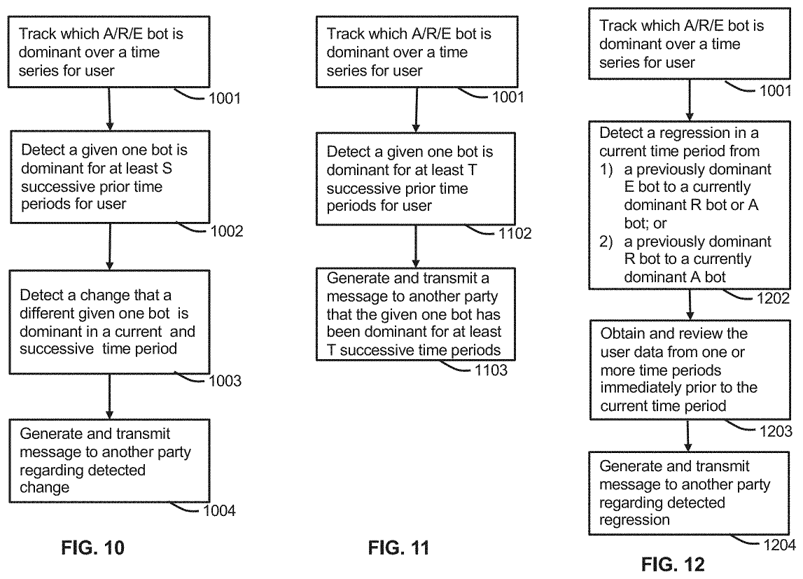

Turning to FIG. 10, an example embodiment is provided for computing a status update about a user, and transmitting the same to another party (e.g. a caregiver of the user, a doctor of the user, etc.).

Block 1001: The CLS bot of the user tracks which A bot, R bot or E bot is dominant over a time series. Alternatively, the CLS bot tracks which behavior or psychological category is dominant over a time series for the user.

Block 1002: The CLS bot detects that a given one bot (e.g. one the A, R or E bots) is dominant for at least S successive time periods immediately prior to the current time for the user. Alternatively, it is detected that one of the behavioral or psychological categories is dominant for at least S successive time periods. For example, for the previous 3 days, the A bot has been dominant; or, for the previous 3 days, the user has been dominantly focused on Topic 1.

Block 1003: The CLS bot detects a change that a different given bot is dominant in a current and successive time period. For example, today, the R bot is dominant; or, today, the user has been dominantly focused on Topic 2.

Block 1004: The CLS bot detects and transmits a message to another party regarding the detected change.

Turning to FIG. 11, another example embodiment is provided for computing a status update about a user, and transmitting the same to another party (e.g. a caregiver of the user, a doctor of the user, etc.).

FIG. 11 starts with block 1001 and then proceeds to block 1102.

Block 1102: The CLS bot detects that a given one bot (e.g. one the A, R or E bots) is dominant for at least T successive time periods immediately prior to the current time for the user. Alternatively, it is detected that one of the behavioral or psychological categories is dominant for at least T successive time periods. For example, for the previous 5 days, the A bot has been dominant; or, for the previous 5 days, the user has been dominantly focused on Topic 1.

Block 1103: The CLS bot generates and transmits a message to another party that the given one bot has been dominant for at least T successive time periods.

This could be positive news, if for example, the R bot or the E bot is dominant. Otherwise, if the A bot is dominant, it could be undesirable news.

Turning to FIG. 12, another example embodiment is provided for computing a status update about a user, and transmitting the same to another party (e.g. a caregiver of the user, a doctor of the user, etc.).

FIG. 12 starts with block 1001 and then proceeds to block 1202.

Block 1202: The CLS bot detects a regression from a previously dominant E bot to a currently dominant R bot or A bot; or a regression from a previously dominant R bot to a currently dominant A bot. Alternatively, the CSL bot detects a regression from a more positive psychological score to a lower psychological score.

Block 1203: The CLS bot obtains and reviews the user data from one or more time periods immediately prior to the current time period. In this way, the CLS bot or the other party can use the used data from the prior time periods to determine why the user regressed. For example, sometimes abuse or threats from another person cause the user to regress.

In an example embodiment, the user data from the prior time periods includes audio data or video data, or both. The CLS bot uses audio recognition to process the audio data to identify if there is are other voices from the user's voice and analyses what the other voice(s) is/are saying. The CLS bot uses image recognition to process the video data to identify if there are other people in the vicinity of the user, and analyses the body pose(s) of the one or more other people and analyses the body pose of the user. In a more general example embodiment, the CLS bot analyses the user data from the immediately prior one or more time periods to identify a potential reason for the user's regression.

Block 1204: The CSL bot generates and transmits a message to another party regarding the detected regression.

In blocks 1004, 1103 and 1204, if the generated message reports that the user has regressed or has stalled in a lower psychological category (e.g. focused on Topic 1), then, in some example embodiments, the CLS bot automatically inserts recommendations in to the message. The recommendations help the other party to progress from a lower psychological category (e.g. focused on Topic 1) to a more positive psychological category (e.g. focused on Topic 2 or Topic 3).

In a further example aspect, these recommendations are intelligently generated for the user based on the success of other people. For example, if the given user is regressed back to focusing on Topic 1, or the A bot is dominant, then the CLS bot searches for other users that have similar characteristics to the given user (e.g. stage of dementia, age, interests, behavioral attributes, gender, etc.). This is called a look-a-like user search. The CLS bot then identifies which of these other look-a-like users have progressed from focusing on Topic 1 to focusing on Topic 2, and further identifies the actions that they took or the actions that their caregivers took, or both, to make the progression. The CLS bot then uses these actions of these look-a-like users or their caregivers, or both, to generate recommendations for the given users.

Example Embodiment for Selecting and Updating Bots of Different Users

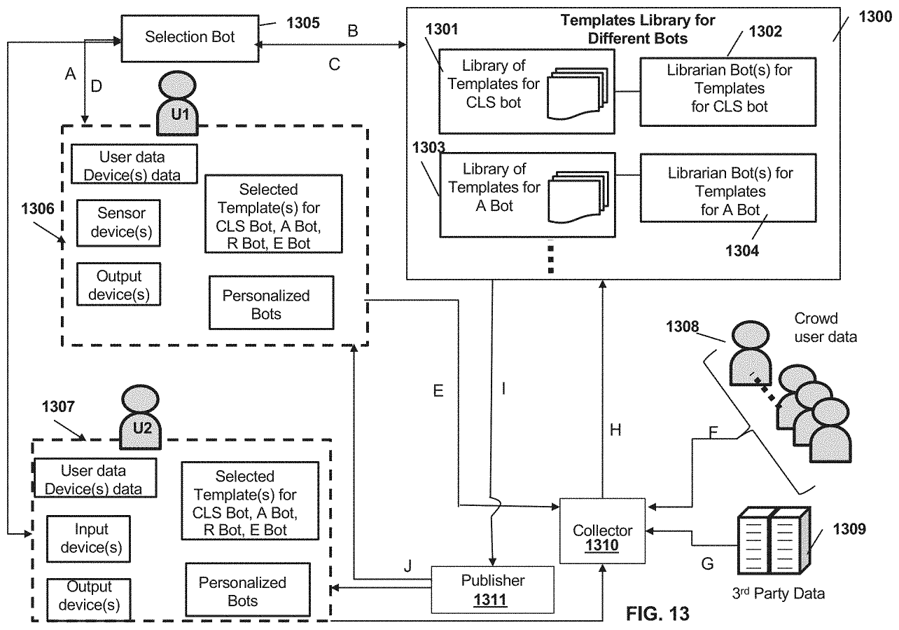

Turning to FIG. 13, an example system is shown for selecting the CLS bot, A bot, R bot, and E bot for a given user, and how data from other users can be used to update their bots over time.

In FIG. 13, a templates library 1300 is provided for different bots. In particular, each template includes data science, rules, data, and search algorithms that are used to execute a CLS bot, an A bot, a R bot and an E bot.

The templates are used to help new users (e.g. User 1, User 2) to more quickly obtain bots, or update their bots, so that they are receiving effective and personalized assistance.

The components and overall process of FIG. 13 are described below.

In particular, a user U1 uses a system 1306 of devices and software to interact with the CLS bot. Their system 1306 includes one or more sensor devices, one or more output devices, and their user data and device data.

At operation A, information about the user (e.g. user data) and their devices (e.g. device data) is provided to a selection bot 1305. The user data includes, for example, their name, their age, their language, their gender, state of dementia, behavior attributes, interests, likes, dislikes, subtopics related to Topic 1, subtopics related to Topic 2, their demographic information, their social network information, and their experiences (e.g. travel, previous projects, skills, and work experiences). This information, for example, can be provided by the caregiver, family members, or friends of the user. Their device data includes, for example, the types of devices they are user, which identifies the types of sensor devices and types of output devices that are available. This information can be provided automatically using the user's personal bot, could be provided by semi-manual input or manual input, or a combination thereof.

In an example embodiment, the personal bots (e.g. the CLS bot, the A bot, the R bot, the E bot) of the user U1 is specific to themselves, and executes operations locally on the device(s) of U1.

At operation B, the selection bot 1305 accesses the templates library 1300 to find templates that would be suitable for the user U1. The templates library includes a library of templates specific to the CLS bot 1301, a library of templates specific to the A bot 1303, and other templates for the other bots (e.g. the R bot, the E bot). Within the library of templates for the CLS bot 1301, there are templates that are suitable for different devices or for different users, or both. The selection bot 1305 uses the user data or the device(s) data, or both, of the user U1 to run a query to find and select an appropriate template (or templates) for the user U1.

At operation C, the selection bot 1305 obtains the selected templates from the library 1300 for each of the CLS bot, the A bot, the R bot, and the E bot. At operation D, the selection bot 1305 provides the one or more selected templates to U1's system 1306.

The selected template is provisioned on the system 1306 for the user U1. The personal bot of the user U1 personalizes the selected template(s) for the user based on known information of the user U1, thereby creating one or more personalized templates for the user U1. Through observed user interaction with the input device(s) and output device(s) in the system 1306, the personalized bots (e.g. the CLS bot, the A bot, the R bot, the E bot) over time dynamically adjust and modify the personalized templates that are specific to the user U1. In effect, different versions of the personalized templates are created for the user U1, as their behavior, experiences and emotions change over time. In other words, the personalized bots for the user U1 can develop new algorithms, new data science parameters, new data sources, new data, etc. to assist the user U1 in their behavioral progress, and these developments are captured in the personalized templates.

At operation E, data from U1's system 1306 is fed back to a collector module 1310. The feedback data includes, for example, raw user data in relation to the user U1, derivatives of the raw data, the changes made by the personalized bots (e.g. the CLS bot, the A bot, the R bot, the E bot) to generate more personalized version of the template, or a combination thereof. The feedback data is also tagged with the user data and device data, which could be subject to change over time.

The collector module 1310, also herein referred to as a collector, also collects data from other systems 1307 of other users. For example, at operation F, crowd data from many other users 1308 is fed back to the collector 1310. Crowd data includes, for example, the interaction of other users with their respective user devices.

At operation G, the collector 1310 also collects data from third-party data sources 1309. Non-limiting examples of third-party data sources include databases in relation to clinical databases, social media networks of family members of users, and databases in relation to cognitive science. These third-party data sources include publicly available data sources and privately available data sources. In an example embodiment, the collector 1310 is a system that includes a collector bot itself, or a system of collector bots. For example, there is a collector bot for each data source.

The collector 1310 ingests and pre-processes this data for storage and for access by one or more librarian bots 1302, 1304.

At Operation H, a given librarian bot 1302 obtains data pertinent to the CLS bot from the collector 1310 and uses this information to at least one of: modify an existing template, delete an existing template, and build a new template. In other words, the librarian bot 1302 uses machine intelligence to update the one or more templates in the library 1301 based on the information obtained by the collector 1310. This updating process could be continuous or occur at timed intervals. The updated templates helps new users to have more up-to-date information and processes.

In an example embodiment, each domain library has a corresponding librarian bot. For example, the library of templates for the A bot 1303 is associated with one or more librarian bots 1304.

The librarian bot 1302 for the CLS bot provides the one or more updated templates to a publisher module 1311 (i.e. Operation I), also herein called a publisher, and the publisher 1311 transmits the one or more updated templates to the relevant user systems. In particular, the publisher 1311 has computing processes that determine which particular updated templates should be transmitted to which particular user systems. In the example of FIG. 13, the publisher 1311 transmits a certain updated template to the system 1306 of the user U1 (i.e. Operation J).

In response, the personalized bots of the user U1 receives this updated template and incorporates this updated template when executing computing processes. The incorporation process includes, for example, adapting any previous personalizations that are specific to the user U1. This closes the feedback loop from the collaborative network to the user U1.

The selection bot, the templates library, the collector 1310, and the publisher 1311 are, for example, part of the conversational limbic computing system 100.

The following is a more detailed discussion of the selection bot 1305.

The selection bot 1305 can use one or more types of computations or algorithms to select an appropriate template based on the provided (e.g. user data, device data, etc.). These computations are based on matching a given user system (e.g. system 1306) to one or more templates. Various types of current known and future known matching algorithms can be used to make a selection.

In an example implementation, the templates are tagged with predefined user attributes and predefined device attributes. The selection bot 1301 identifies the one or more templates that are tagged with the attributes that match the provided data.

In another example implementation, the selection bot 1305 utilizes bipartite graphs to compute bipartite matching computations. For example, users represent one set of nodes and the templates represent another set of nodes in a bipartite graph. In an example embodiment, unweighted bipartite graphs are used to perform the matching. In another example, weighted bipartite graphs are used to perform the matching.

In another example implementation, the selection bot 1305 utilizes fuzzy matching algorithms.

In another example implementation, the selection bot 1305 uses look-alike algorithms to match a user with a template. For example, the selection bot 1305 has processed the existing data to identify that many users having personal attributes and device attributes of the set [X] use the template Y. Therefore, the selection bot determines that a potential user that also has the attributes [X] should use the template Y. It will be appreciated that different attributes can be weighted differently.

In another example implementation, the selection bot 1305 uses a neural network to predict (or output) which template will best match a user and their device(s). The neural network is trainable based on existing data of users and their templates.

In another example implementation, the selection bot 1305 computes mutual information between a given attribute (or given attributes) of a user and a given attribute (or given attributes) of a template. The mutual information value measures the mutual dependence between two seemingly random variables. The higher the mutual information value, the higher correlated are these variables, which can be used to determine that a given user and a given template are a matching pair.

In another example implementation, the selection bot 1305 computes one or more Pearson Correlation Coefficients (PCC) between a given attribute of a user and a given attribute of a template. The one or more PCCs are used by the selection bot 1305 to make a selection of a template.

Other matching algorithms can be used. It will also be appreciated that multiple matching algorithms can be combined together in order for the selection bot 1305 to make a selection.

Example Embodiments of Computing Architecture for the Conversational Limbic Computing System

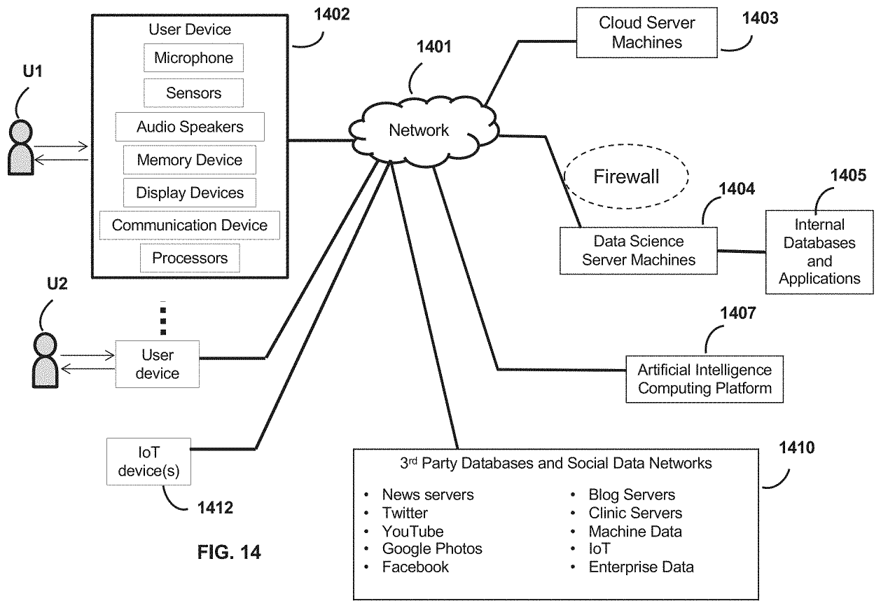

Turning to FIG. 14, an example computing architecture is shown for implementing the conversational limbic computing system 100. A user device 1402 of the user U1, Internet of Things (IoT) devices 1412, cloud computing servers 1403, data science servers 1404, an AI computing platform 1407, and various 3^{rd} party data sources 1410 are able to transmit and receive data via a network 1401, such as the Internet. In an example embodiment, the data science servers 1404 and the internal applications and databases 1405 are in communication with each other over a private network for enhanced data security. In another example embodiment, the servers 1404 and the internal applications and the databases 1405 are in communication with each other over the same network 1401. In an example embodiment, the conversational limbic computing system is implemented on one or more virtual machines that reside on the cloud server machines, the data science server machines and the AI computing platform.

As shown in FIG. 14, example components of the user device 1402 include one or more microphones, one or more other sensors (e.g. cameras, infrared sensors, etc.), audio speakers, one or more memory devices, one or more display devices, a communication device, and one or more processors. The memory devices include, for example, RAM and ROM. The processors, for example, include one or more of: single core processors, multi-core processors, graphic processing units (GPUs), and tensor processing units (TPUs).

In an example embodiment, portions of the CLS bot, the A bot, the R bot and the E bot reside locally on the user device's memory, including frequently used media content packages that are served to the user U1.

In an example embodiment, the user device transmits the sensed user data to the conversational limbic computing system for data processing, such as applying different types of machine learning to extract data features from different types of received data. For example, the cloud computing servers use natural language processing (NLP) algorithms or deep neural networks, or both, to process voice and text data. In another example, the 3^{rd} party cloud computing servers use machine vision, or deep neural networks, or both, to process video and image data. Alternatively, or in addition, these computations can occur locally on the user device.

In an example embodiment, the IoT devices 1412 include one or more of: motion sensors, diaper wetness sensors, weight sensors, display devices (e.g. smart TV, media projector, etc.), audio devices, an actuator to control a door, an actuator to control a water tap, an actuator to control a bed, an actuator to control a mobility aid device (e.g. a wheel chair, a walker, etc.), an actuator to control a toilet, a lighting device, a pill dispenser device, a wearable device on the user, a robot, etc. One or more IoT devices provide data to the CLS bot 102, which helps to select one or more of the A bot, R bot, E bot. In another example embodiment, the use of the A bot, R bot or E bot includes activating one or more IoT devices to complete an action.

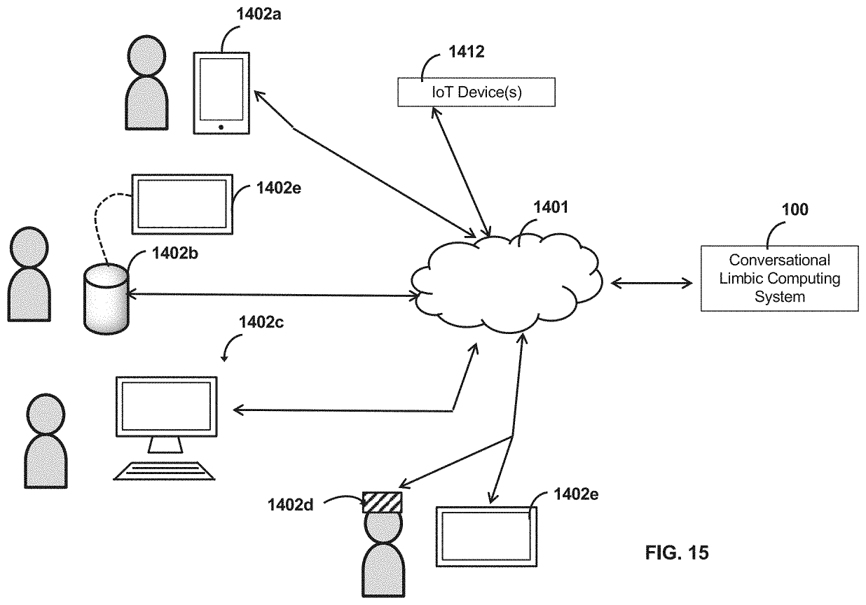

Turning to FIG. 15, different examples of user devices 1042 are shown. In an example embodiment, a user interacts with a mobile device or a tablet 1402a, which has a microphone and camera as sensors, and can provide both audio and visual outputs.

In another example, a user interacts with a home assistance device 1402b like a Google-home device. In particular, the user's voice is recorded and the device 1402b provides an audio response. In an example embodiment, a display device 1402e, which is in data communication with the device 1402b, can also output a visual response.

In another example, the user interacts with a desktop computer or a laptop 1402c.

In another example embodiment, the user interacts with a wearable device 1402d, which includes one or more of a brain signal sensor, a nerve signal sensor and a muscle signal sensors, which senses and compute the thoughts and intentions of the user. The output device is display device 1402e, which also has audio capabilities.

In an example embodiment, these different users are able to communicate with each other using their devices, as their devices are connected to the network 1401. In an example embodiment, these user devices include one or more sensors and one or more output devices that facilitate interaction with the conversational limbic computing system 100.

It will be appreciated that a display device can be a display screen. In some other embodiment, the display device is a multimedia projector that displays projected images. In some other embodiment, the display device is a holographic projector that projects holographic images for viewing.

Example Embodiments of Using Familiar Voices

To help the user feel comfortable and to be engaged with the media content packages, the A bot, R bot or E bot (or a combination thereof) use audio clips or audio data comprising voices of people that are familiar to the user. For example, the audio messages to the user are in the voices of a son or a daughter of the user. Audio messages can also be in the voices of a friend, a grandchild, a sibling, a parent, a relative, etc.

In some embodiments, a person that is familiar to the user records their spoken or sung audio message, and the bot (e.g. one or more of the A bot, the R bot and the E bot) replays that recording. Therefore, when the user hears that recording, the user hears the voice of someone familiar.

In some other embodiments, the CLS bot, the A bot, the R bot and the E bot use synthesized voices of people that are familiar to the user. For example, the voice of a family member is synthesized using voice libraries. In this way, the A bot, the R bot and the E bot can generate or obtain text content and express the text content as audio content in the voice of that family member. In this way, the family member does not need to make an audio recording for every response. For example, a daughter of the user has her own voice library; a brother of the user has his own voice library; and so forth.

In an example embodiment, the user device, which has an audio speaker, also includes an onboard voice synthesizer to locally generate the synthesized voice, in full or in part.

In some example embodiment, the bots (e.g. the Address bot, the Reach bot and the Expand bot) send text data to the user device 1402 as part of a media content package, along with a tag identifying a voice library of a given familiar person. The user device uses the text and the tag to locally generate a synthesized voice of that given familiar person.

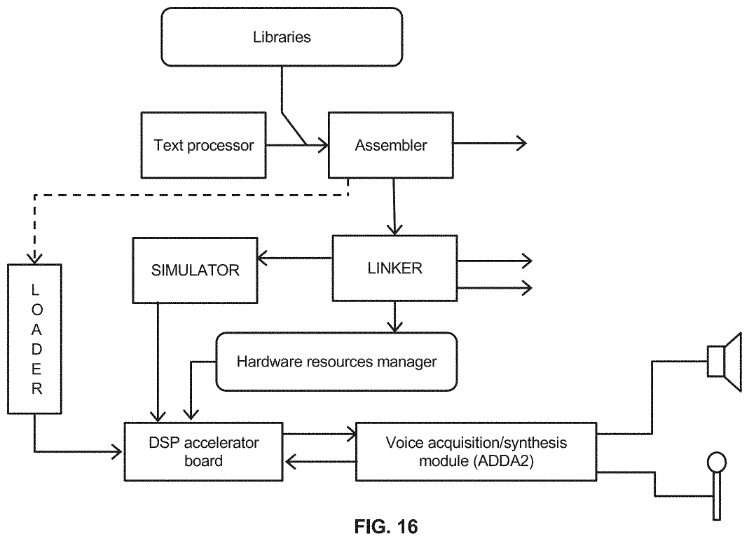

FIG. 16 shows an example embodiment of an onboard voice synthesizer. It is a Digital Signal Processor (DSP) based system that resides on the user device 1402. It includes one or more voice libraries as noted above. It also includes a text processor, an assembler, a linker module, a simulator, a loader, a DSP accelerator module which is managed by a hardware resources manager, and a voice acquisition and synthesis module (e.g. an analog/digital converter and digital/analog converter). The voice acquisition and synthesis module is in data communication with a microphone and an audio speaker.

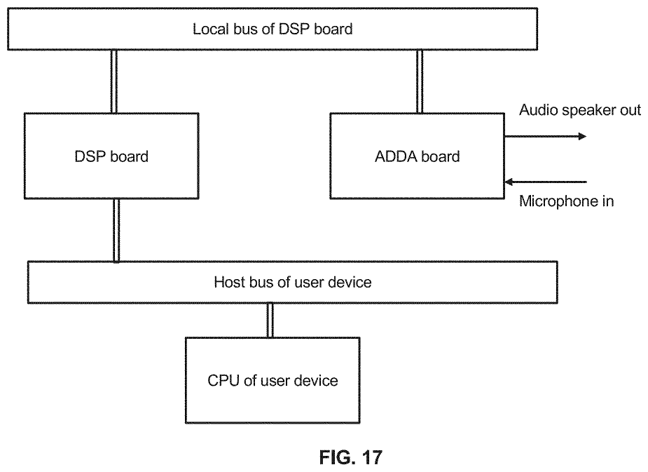

FIG. 17 shows an example subset of components on the user device that facilitate the voice synthesizing capabilities, and these components includes a DSP board/chip, an ADDA2 board/chip, a local bus of the DSP board, a host bus, and a CPU of the smart device. These components, for example, support the software architecture shown in FIG. 16.

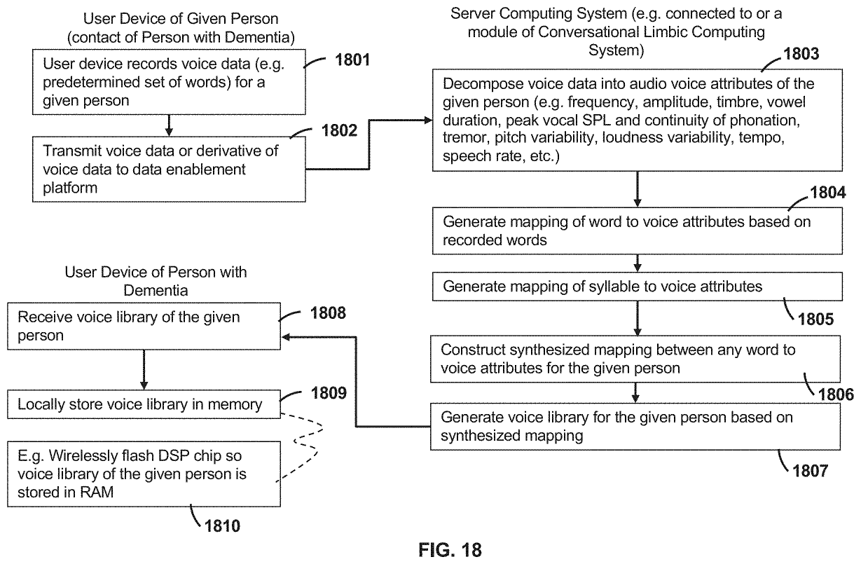

Turning to FIG. 18, example executable instructions are provided for building a voice library, which is used to later generate the synthesized voice.

Block 1801: A user device of familiar person who is a contact of the user (e.g. the caregiver, the daughter, the son, the spouse, etc.) records voice data of the given person. For example, the given person speaks a predetermined set of words.

Block 1802: The user device of the familiar person transmits the voice data or a derivative of voice data to a given computing system. The given computing system can be part of (e.g. a module of) the conversational limbic computing system 100, or can be separate and in communication with the conversational limbic computing system 100. In some example embodiments, the given computing system is implemented using cloud computing servers.

Block 1803: The given computing system decomposes the voice data into audio voice attributes of the familiar person (e.g. frequency, amplitude, timbre, vowel duration, peak vocal SPL and continuity of phonation, tremor, pitch variability, loudness variability, tempo, speech rate, etc.).

Block 1804: The given computing system generates a mapping of word to voice attributes based on recorded words.

Block 1805: The given computing system generates a mapping of syllable to voice attributes.

Block 1806: The given computing system constructs a synthesized mapping between any word to voice attributes for the familiar person.

Block 1807: The given computing system generates a voice library for the familiar person based on synthesized mapping. In some example embodiments, this voice library is stored on the conversational limbic computing system 100.

Block 1808: The user device 1402 that belongs to the user receives the voice library of the familiar person.

Block 1809: The user device 1402 of the user locally stores the voice library in memory. For example, the system wirelessly flashes the DSP chip so that the voice library of the given person is stored in RAM on the user device (block 1810). This data can also be stored in some other manner on the user device.

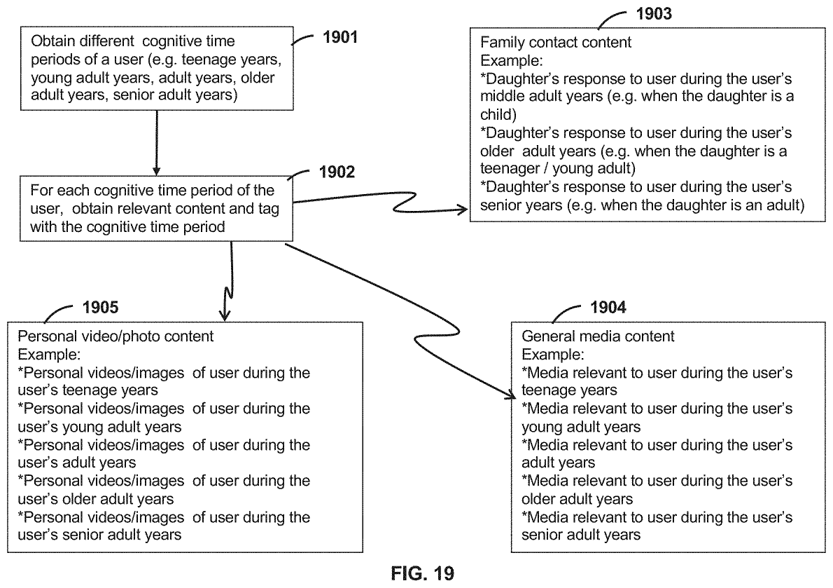

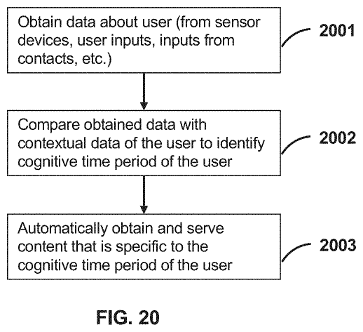

Turning to FIGS. 19 and 20, example embodiments of processes are provided for mapping and using data (e.g. audio data, voice data, photos, videos, etc.) that are specific to a user's cognitive time period. In particular, it is recognized that a person with dementia or Alzheimer's lives in the past. In other words, their cognitive state of time and place may not align with the reality of time and place. For example, a person that is 90 years old in the present year (e.g. 2020) and living in a long term care facility has a cognitive state in which they are a younger adult in the 1960s and in their own home at that time period.

The CLS bot 102 recognizes the user's cognitive state in relation to a specific time or location, or both, and selects the content relevant to that specific time or location, or both. For example, if the user is 90 years old in the present year (e.g. the year 2020) and their cognitive time period is in the 1960s, then the responses and content provided by the CLS bot will be specific to that time period. For example, voice responses from family and friends are played as if the voice responses from family and friends were provided in the 1960s. Personal photo or video content that is displayed by the CLS bot is specific to the user in 1960s. General media content (e.g. music, tv shows, media references, movies, public photos, news items, etc.) that is specific to the 1960s is played.

FIG. 19 shows a process to obtain time specific mappings. At block 1901, CLS computing system 100 obtains different cognitive time periods of a user. For example, these time periods are based on their age ranges, such as: their teenage years, their young adult years, their middle adult years, their older adult years, and their senior adult years. For example, during a person's teenage years, the time period is 1950 to 1957; during their young adult years, the time period is 1957 to 1967; during their middle adult years, the time period is from 1967 to 1980; and so forth. It will be appreciated that the age ranges can vary (e.g. 10 year intervals, 5 year intervals, non-equal year ranges for different age periods, etc.). In an example embodiment, these age ranges are pre-determined parameters already established in the CLS computing system 100. This information is stored in the contextual data 104. Other metadata that indicates whether a user is cognitively in a given age range is stored in association with the given age range. For example, if a user speaks a certain way (e.g. language cues) or uses certain phrases that indicate the user's cognitive time period is living in the young adult years, then those language cues and those certain phrases are metadata that is mapped to the young adult years of that user, and is stored as contextual data 104.

At block 1902, for each cognitive time period of the user, the CLS computing system 100 obtains relevant content and tags the same with the corresponding cognitive time period. This content is stored in the content database 108.

For example, at block 1903, a family member of the user, such as the user's daughter, has responses to the user that are specific to each time range of the user. For example, during the user's middle adult years and when the daughter is a child, the daughter provides response as if they were a child. This can be done using voice synthesis or by using recorded voice data and phrasing (e.g. from home videos). In another example, during the user's older adult years and when the daughter is a teenager or young adult, the daughter's responses are provided as if she were a teenager or young adult. In another example, during the user's senior adult years and when the daughter is a middle-aged adult, the daughter's responses are provided as if she were a middle-aged adult. These responses are stored and labelled in the content database 108.

Similarly, personal photos or videos, or both, are labelled by their relevance to the user's different age ranges and are stored in the content database (block 1905). Similarly, general media content is labelled by their relevant to the user's different age ranges and are stored in the content database (block 1904).

In FIG. 20, computer executable instructions are provided for serving content that is specific to the user's cognitive time period. At block 2001, the CLS computing system obtains data about the user (e.g. form sensor devices, user inputs, inputs from family and friends, inputs from doctors, etc.). At block 2002, this data is compared with the obtained data with the contextual data of the user in order to identify the user's cognitive time period. For example, data from family, doctors or caregivers indicate that the user has a cognitive state that is set in the present during the daytime hours, and then transitions to another cognitive state that is set in their teenage years during in the evening and at night. This is a form of sundowning. In another example, based on what the user is currently saying as detected by the microphone, the CLS computing system identifies the user's current cognitive state of mind is in a certain time period.

At block 2003, the CLS computing system then automatically obtains content (e.g. responses from family or friends, personal videos or photos, general media, etc.) from the content database 108 that is specific to their cognitive time period. This obtained data is then played to the user via one or more output devices 112.

Below is a general example embodiment and example aspects.

In a general example embodiment, a computing system comprising multiple software bots that interact with a user device is provided. The software bots comprise: a conversational limbic system (CLS) bot associated with a user of the user device; an Address bot that serves media content packages to redirect the user away from TOPIC 1, wherein Topic 1 is associated with negative emotions or behaviors; a Reach bot that serves media content packages to engage the user with Topic 2, wherein the Topic 2 is associated with positive emotions or behaviors and the Topic 2 is familiar to the user; an Expand both that serves media content packages to engage the user with Topic 3, wherein the Topic 3 is associated with positive emotions or behaviors and the Topic 3 is unfamiliar to the user; and wherein the CLS bot adds a tag to the user data as being associated with one or more of Topic 1, Topic 2 and Topic 3, and then the CLS bot uses at least the tag to selects and activates one of the Address bot, the Reach bot and the Expand bot.

In an example aspect, if the tag associates the user data with Topic 1, then the CLS bot activates the Address bot.

In another example aspect, if the tag associates the user data with Topic 2, then the CLS bot activates the Reach bot or the Expand bot.

In another example aspect, if the tag associates the user data with Topic 3, then the CLS bot activates the Expand bot.

In another example aspect, the user data comprises one or more of: audio data and visual data.

In another example aspect, the user data comprises text data, which is derived from audio data detected by the user device.

In another example aspect, the user data comprises one or more of motion data, biometrics data, brain signal data, nerve signal data and muscle signal data.

In another example aspect, the Topic 1 relates to fear, uncertainty, depression, or agitation, or a combination thereof.

In another example aspect, the CLS bot computes one or more psychological scores for the user using the user data and the tag, and uses the one or more psychological scores to select and activate one of the Address bot, the Reach bot and the Expand bot.

In another example aspect, the Address bot includes a first graph database that comprises nodes representing different subtopics under the Topic 1; the Reach bot includes a second graph database that comprises nodes representing different subtopics under the Topic 2; and the Expand bot includes a second graph database that comprises nodes representing different subtopics under the Topic 3.

In another example aspect, the Address bot includes a graph database that comprises subtopic nodes under the Topic 1, and people nodes and response nodes are related to the subtopic nodes by edges in the graph database; and wherein the response nodes comprise media content or data links to the media content to form the media content packages to redirect the user away from the Topic 1.

In another example aspect, the media content includes seed data, and the Address bot uses the seed data to generate queries to one or more third-party databases to obtain external media content similar to the seed data, and the external media content is used to form the media content packages to redirect the user away from the Topic 1.

In another example aspect, the Reach bot includes a graph database that comprises subtopic nodes under the Topic 2, and people nodes and response nodes are related to the subtopic nodes by edges in the graph database; and wherein the response nodes comprise media content or data links to the media content to form the media content packages to engage the user with the Topic 2.

In another example aspect, the media content includes seed data, and the Reach bot uses the seed data to generate queries to one or more third-party databases to obtain external media content similar to the seed data, and the external media content is used to form the media content packages to engage the user with the Topic 2.

In another example aspect, the Expand bot includes a graph database that comprises subtopic nodes under the Topic 3, and people nodes and response node are related to the subtopic nodes by edges in the graph database; and wherein the response nodes comprise media content or data links to the media content to form the media content packages to engage the user with the Topic 3.

In another example aspect, the media content includes seed data, and the Expand bot uses the seed data to generate queries to one or more third-party databases to obtain external media content similar to the seed data, and the external media content is used to form the media content packages to engage the user with the Topic 3.

In another example aspect, the computing system further comprises memory for storing templates for CLS bot, templates for the Address bot, templates for the Reach bot, and templates for the Expand bot; and a selection bot automatically picks one template for each of the CLS bot, the Address bot, the Reach bot, and the Expand bot for the user based on user attributes.

In another example aspect, the Expand bot includes a teaching subtopic under the Topic 3; and the Expand bot serves a media content package to the user to prompt the user to teach a subtopic under the Topic 2.

In another example aspect, after the media content package has been served to the user, the Expand bot generates teaching content related to the subtopic under the Topic 2 by recording the user.

In another example aspect, the Expand bot transmits the teaching content to a second user.

In another example aspect, the CLS bot computes and records which of the Address bot, the Reach bot or the Expand bot is a dominant bot for the user in successive time periods prior to a given time period; and generating and transmitting a message to another party after detecting a different bot is dominant in the given time period compared to the dominant bot in the successive time periods.

In another example aspect, the CLS bot detects if the Address bot has been dominantly activated in at least a threshold number of successive time periods; and, responsive to the detection, the CLS bot generates and transmits a message to another party regarding the detection.

In another example aspect, the CLS bot generates and includes a recommendation in the message to help the other party psychologically progress the user; and wherein the CLS bot automatically obtains data about other users who have progressed and that have similar personal attributes to the user in order to generate the recommendation.

In another example aspect, the CLS bot detects a regression comprising the Reach bot being previously dominant and the Address bot being dominant in a current time period, or the Expand bot being previously dominant and the Reach bot or the Address bot being dominant in the current time period; and, responsive to detecting the regression, the CLS bot review the user data from one or more time period immediately prior to the current time period.

In another example aspect, the CLS bot uses historical user data to compute predicted behavior data of the user of a future time period; and the CLS bot uses the predicted behavior data of the user to activate one of the Address bot, the Reach bot and the Expand bot prior to the future time period.

In another example aspect, if the user's reaction to a given media content package is negative, then media content that forms the given media content package is added to a black list associated with the user.

In another example aspect, at least one of the Address bot, the Reach bot and the Expand bot send text data and a tag identifying a voice library of a given familiar person to the user device for the user device to use to generate a synthesized voice of that given familiar person; and wherein the user device locally stores the voice library of the given familiar person.

In another example aspect, responsive to detecting a cognitive time period of a user, at least one of the Address bot, the Reach bot and the Expand bot obtain and play content specific to the cognitive time period of the user.

It will be appreciated that any module or component exemplified herein that executes instructions may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the servers or computing devices or accessible or connectable thereto. Any application or module herein described may be implemented using computer readable/executable instructions that may be stored or otherwise held by such computer readable media.

It will be appreciated that different features of the example embodiments of the system and methods, as described herein, may be combined with each other in different ways. In other words, different devices, modules, operations, functionality and components may be used together according to other example embodiments, although not specifically stated.

The steps or operations in the flow diagrams described herein are just for example. There may be many variations to these steps or operations according to the principles described herein. For instance, the steps may be performed in a differing order, or steps may be added, deleted, or modified.

It will also be appreciated that the examples and corresponding system diagrams used herein are for illustrative purposes only. Different configurations and terminology can be used without departing from the principles expressed herein. For instance, components and modules can be added, deleted, modified, or arranged with differing connections without departing from these principles.

Although the above has been described with reference to certain specific embodiments, various modifications thereof will be apparent to those skilled in the art without departing from the scope of the claims appended hereto.

1. A computing system comprising multiple software bots that interact with a user device, and the software bots comprise:
a conversational limbic system (CLS) bot associated with a user of the user device;
an Address bot that serves media content packages to redirect the user away from TOPIC 1, wherein Topic 1 is associated with negative emotions or behaviors;
a Reach bot that serves media content packages to engage the user with Topic 2, wherein the Topic 2 is associated with positive emotions or behaviors and the Topic 2 is familiar to the user;
an Expand both that serves media content packages to engage the user with Topic 3, wherein the Topic 3 is associated with positive emotions or behaviors and the Topic 3 is unfamiliar to the user; and
wherein the CLS bot adds a tag to the user data as being associated with one or more of Topic 1, Topic 2 and Topic 3, and then the CLS bot uses at least the tag to selects and activates one of the Address bot, the Reach bot and the Expand bot.

2. The computing system of claim 1 wherein, if the tag associates the user data with Topic 1, then the CLS bot activates the Address bot.

3. The computing system of claim 1 wherein, if the tag associates the user data with Topic 2, then the CLS bot activates the Reach bot or the Expand bot.

4, The computing system of claim 1 wherein, if the tag associates the user data with Topic 3, then the CLS bot activates the Expand bot.

5. The computing system of claim 1 wherein the user data comprises one or more of: audio data and visual data.

6. The computing system of claim 1 wherein the user data comprises text data, which is derived from audio data detected by the user device.

7. The computing system of claim 1 wherein the user data comprises one or more of motion data, biometrics data, brain signal data, nerve signal data and muscle signal data.

8. The computing system of claim 1 wherein the Topic 1 relates to fear, uncertainty, depression, or agitation, or a combination thereof.

9. The computing system of claim 1 wherein the CLS bot computes one or more psychological scores for the user using the user data and the tag, and uses the one or more psychological scores to select and activate one of the Address bot, the Reach bot and the Expand bot.

10. The computing system of claim 1 wherein the Address bot includes a first graph database that comprises nodes representing different subtopics under the Topic 1; the Reach bot includes a second graph database that comprises nodes representing different subtopics under the Topic 2; and the Expand bot includes a second graph database that comprises nodes representing different subtopics under the Topic 3.

11. The computing system of claim 1 wherein the Address bot includes a graph database that comprises subtopic nodes under the Topic 1, and people nodes and response nodes are related to the subtopic nodes by edges in the graph database; and wherein the response nodes comprise media content or data links to the media content to form the media content packages to redirect the user away from the Topic 1.

12. The computing system of claim 11 wherein the media content includes seed data, and the Address bot uses the seed data to generate queries to one or more third-party databases to obtain external media content similar to the seed data, and the external media content is used to form the media content packages to redirect the user away from the Topic 1.

13. The computing system of claim 1 wherein the Reach bot includes a graph database that comprises subtopic nodes under the Topic 2, and people nodes and response nodes are related to the subtopic nodes by edges in the graph database; and wherein the response nodes comprise media content or data links to the media content to form the media content packages to engage the user with the Topic 2.

14. The computing system of claim 13 wherein the media content includes seed data, and the Reach bot uses the seed data to generate queries to one or more third-party databases to obtain external media content similar to the seed data, and the external media content is used to form the media content packages to engage the user with the Topic 2.

15. The computing system of claim 1 wherein the Expand bot includes a graph database that comprises subtopic nodes under the Topic 3, and people nodes and response node are related to the subtopic nodes by edges in the graph database; and wherein the response nodes comprise media content or data links to the media content to form the media content packages to engage the user with the Topic 3.

16. The computing system of claim 15 wherein the media content includes seed data, and the Expand bot uses the seed data to generate queries to one or more third-party databases to obtain external media content similar to the seed data, and the external media content is used to form the media content packages to engage the user with the Topic 3.

17. The computing system of claim 1 comprising memory for storing templates for CLS bot, templates for the Address bot, templates for the Reach bot, and templates for the Expand bot; and a selection bot automatically picks one template for each of the CLS bot, the Address bot, the Reach bot, and the Expand bot for the user based on user attributes.

18. The computing system of claim 1 wherein the Expand bot includes a teaching subtopic under the Topic 3; and the Expand bot serves a media content package to the user to prompt the user to teach a subtopic under the Topic 2.

19. The computing system of claim 18 wherein, after the media content package has been served to the user, the Expand bot generates teaching content related to the subtopic under the Topic 2 by recording the user.

20. The computing system of claim 19, wherein the Expand bot transmits the teaching content to a second user.

21. The computing system of claim 1 wherein the CLS bot computes and records which of the Address bot, the Reach bot or the Expand bot is a dominant bot for the user in successive time periods prior to a given time period; and generating and transmitting a message to another party after detecting a different bot is dominant in the given time period compared to the dominant bot in the successive time periods.

22. The computing system of claim 1 wherein the CLS bot detects if the Address bot has been dominantly activated in at least a threshold number of successive time periods; and, responsive to the detection, the CLS bot generates and transmits a message to another party regarding the detection.

23. The computing system of claim 22 wherein the CLS bot generates and includes a recommendation in the message to help the other party psychologically progress the user; and wherein the CLS bot automatically obtains data about other users who have progressed and that have similar personal attributes to the user in order to generate the recommendation.

24. The computing system of claim 1 wherein the CLS bot detects a regression comprising the Reach bot being previously dominant and the Address bot being dominant in a current time period, or the Expand bot being previously dominant and the Reach bot or the Address bot being dominant in the current time period; and, responsive to detecting the regression, the CLS bot review the user data from one or more time period immediately prior to the current time period.

25. The computing system of claim 1 wherein the CLS bot uses historical user data to compute predicted behavior data of the user of a future time period; and the CLS bot uses the predicted behavior data of the user to activate one of the Address bot, the Reach bot and the Expand bot prior to the future time period.

26. The computing system of claim 1 wherein if the user's reaction to a given media content package is negative, then media content that forms the given media content package is added to a black list associated with the user.

27. The computing system of claim 1 wherein at least one of the Address bot, the Reach bot and the Expand bot send text data and a tag identifying a voice library of a given familiar person to the user device for the user device to use to generate a synthesized voice of that given familiar person; and wherein the user device locally stores the voice library of the given familiar person.

28. The computing system of claim 1 wherein, responsive to detecting a cognitive time period of a user, at least one of the Address bot, the Reach bot and the Expand bot obtain and play content specific to the cognitive time period of the user.
